(19) United States
(12) Patent Application Publication
(10) Pub. No.: US 2022/0270168 A1
(43) Pub. Date: Aug. 25, 2022

(54) SYSTEMS AND METHODS FOR INTELLIGENT ELECTRONIC RECORD MANAGEMENT

(71) Applicant: Block, Inc., San Francisco, CA (US)

(72) Inventors: Ronak Daya, Brooklyn, NY (US); Maya Hope, Berkeley, CA (US); Kevin Suehnholz, Irvington, NY (US); SatAmrit Khalsa, Brooklyn, NY (US)

(21) Appl. No.: 17/182,518

(22) Filed: Feb. 23, 2021

(51) Int. Cl. G06Q 40/02; G06N 20/00; G06N 5/04; G06Q 20/40; G06Q 30/04

(52) U.S. Cl. CPC G06Q 40/025; G06N 20/00; G06N 5/04; G06Q 20/405; G06Q 20/4037; G06Q 30/04; G06Q 20/042

(57) ABSTRACT

Intelligent electronic record management is described herein. A service provider can receive, via a payor user interface, electronic records associated with a payor. The service provider can recommend, using a machine-trained model, that a payment associated with a first electronic record be paid using a first form of payment. The service provider can settle the payment associated with the first electronic record using the first form of payment. The service provider can additionally settle a payment associated with a second electronic record using a second form of payment recommended for payment of the second electronic record.

### TECHNICAL FIELD

Managing invoices, bills, and/or other electronic records can be difficult for payors. For example, different invoices can be associated with different payees, different forms of payment (e.g., check, credit card, debit card, automated clearing house (ACH) transfer, wire transfer, etc.), different due dates, different repayment terms, and/or the like.

### BRIEF DESCRIPTION OF THE FIGURES

Features of the present disclosure, its nature and various advantages, will be more apparent upon consideration of the following detailed description, taken in conjunction with the accompanying figures.

FIG. 1 illustrates an example environment for performing techniques described herein.

FIGS. 2A-2I illustrate example graphical user interfaces that can be presented via a payor user interface, as described herein.

FIG. 3 illustrates an example graphical user interface that can be presented via a payee user interface, as described herein.

FIG. 4 illustrates an example process for training a model, as described herein.

FIG. 5 illustrates an example process for determining an optimal payment mechanism associated with a record and/or settling payment for such record, as described herein.

FIG. 6 illustrates an example process for generating a credit offer for a payor and/or settling payment for a record based at least in part on the credit offer, as described herein.

FIG. 7 illustrates another example process for generating a credit offer for a payor and/or settling payment for a record based at least in part on the credit offer, as described herein.

FIG. 8 illustrates an example merchant ecosystem for facilitating, among other things, techniques described herein.

FIG. 9 illustrates additional details associated with individual components of the merchant ecosystem described above in FIG. 8.

In the figures, the left-most digit(s) of a reference number identifies the figure in which the reference number first appears. The use of the same reference numbers in different figures indicates similar or identical items or features. The figures are not drawn to scale.

### DETAILED DESCRIPTION

Techniques described herein relate to intelligent electronic record management. For example, techniques described herein enable users (e.g., payors and/or payees) to easily manage payments associated with electronic records in a single location, without needing to expend resources tracking various payments, matching different inflows to outflows, and figuring out what payment duration and source is optimal for them. In an example, techniques described herein enable payors and/or payees to send their invoices, bills, and/or other electronic records requesting payment to a service provider for processing and handling payment thereof. That is, techniques described herein enable payors to manually enter, scan, forward, retrieve (e.g., via application programming interfaces (APIs)), etc. invoices, bills, and/or other electronic records requesting payment to a service provider. In some examples, the service provider can automatically detect the payor, the payee, payment date, form(s) of payment accepted, and amount of an invoice, bill, and/or other electronic record, and manage the payment of the invoice, bill, and/or other electronic record, while optimizing the payment date and source (e.g., form of payment) to maximize the cash that the payor and/or payee has available for their business operations and/or otherwise optimize payment for the payor and/or payee. In some examples, the service provider can utilize intelligence (e.g., machine-trained model(s)) for such payment management and/or optimization.

In at least one example, in addition to intelligent electronic record management services, the service provider can provide various services to payors. Examples of such services include payment processing services, payroll services, invoicing services, peer-to-peer payment services, lending services, and/or the like. Further, the service provider can store data associated with multiple payors that utilize the service provider for one or more of the various services, and in some examples, the service provider can surface a relevant service from among available services depending on the context and characteristics of the electronic record. For example, if the electronic record relates to lending services, the service provider accesses the lending service interface to enable processing of the electronic record. Techniques described herein enable the service provider to leverage data associated with the various services and/or one or more of the payors to intelligently (e.g., using machine-trained model(s)) determine optimal payment mechanisms, and in some examples apply the payment mechanisms on a per-electronic record basis. Such an “optimal payment mechanism” can indicate a form of payment for a particular electronic record (e.g., check, credit card, debit card, automatic clearing house (ACH) transfer, wire transfer, cryptocurrency, peer-to-peer, real time, etc.), a date and/or time for making the payment, and/or the like. In at least one example, “optimal” can refer to optimizing for cash flow (of the payor and/or payee), optimizing for time, optimizing for network constraints, optimizing for speed, optimizing for keeping the credit limited (for the payor and/or the payee), etc. Then, the service provider can utilize the optimal payment mechanism for settling payment for the electronic record (and in some examples, other electronic records similar to the record, or other available records). That is, the service provider can utilize data associated with the various services and/or the one or more payors to determine payors' inflow and intelligently manage, at least in part, their outflows by taking the complexity out of creating each payment connection that the payors need to make. Through techniques described herein, the service provider creates efficiencies for payors and networks by automating individual payments, triaging multiple payments of electronic records over a period of time based on cashflow, extending credit or credit-like offerings in places they were not able to with conventional payment systems, and freeing up more time and/or money to manage their operating cash flow.

In at least one example, techniques described herein can utilize a stored balance of a payor managed by the service provider for payment of at least some invoices, bills, and/or other electronic records requesting payment. In some examples, the stored balance can be generated based at least in part on proceeds of payment(s) processed by the service provider on behalf of the payor (e.g., via a payment processing service), peer-to-peer payment(s) received by the service provider on behalf of the payor (e.g., via a peer-to-peer payment service), receivables from invoice(s) invoiced by the service provider on behalf of the payor (e.g., via an invoicing service), and/or the like. In some examples, a portion of the stored balance can be used to pay an invoice, bill, and/or other electronic record. In some examples, a payment instrument associated with the stored balance can be used to pay an invoice, bill, and/or other electronic record. In some examples, as portions of the stored balance are used for making payments for invoices, bills, and/or other electronic records, the stored balance can be adjusted.

In some examples, if the stored balance is insufficient for payment of an invoice, bill, and/or other electronic record and/or a determination that credit is an optimal payment mechanism (even if the stored balance is sufficient), the service provider can generate a credit offer for the payor. The credit offer can be generated based at least in part on data associated with the payor indicative of creditworthiness and/or risk. In at least one example, if the payor accepts the credit offer, the service provider can generate and/or increase a credit balance of the payor and settle payment of the invoice, bill, and/or other electronic record on behalf of the payor. That is, the service provider can cause a payment to be paid to a payee of the invoice, bill, and/or other electronic record. In some examples, the service provider can use a preferred form of payment for the payor and/or the payee. The service provider can manage repayment of the credit balance, which can be repaid using proceeds of payment(s) processed by the service provider on behalf of the payor, peer-to-peer payment(s) received by the service provider on behalf of the payor, receivables from invoice(s) invoiced by the service provider on behalf of the payor, payments made by the payor, and/or the like. The unconventional techniques described herein therefore enable a payor an extended period of time to make payments for invoices, bills, and/or other electronic records.

In some examples, for an electronic record that is originally configured to be paid through credit, the service provider can determine that stored balance may be the more appropriate choice of payment mechanism for the payor. Accordingly, settlement of the electronic record can be routed through a stored balance channel instead of a credit channel. In some examples, the service provider can allocate the payments through a plurality of channels, for example, through a combination of credit and stored balance channels, where the allocation is based on data associated with the various services, data associated with the payor that can be indicative of the payor's inflow and/or outflows, data associated with the payee, and/or the like.

Techniques described herein provide improvements over conventional electronic record management technologies. In some examples, payors can expend resources tracking various payments, matching different inflows to outflows, and figuring out what payment duration and source is optimal for them. For example, payors can have one or more sources of funds (e.g., inflows), which can include a stored balance managed by the service provider, credit or other loans (e.g., from the service provider or a third-party), third-party accounts, etc., and payors can have one or more outflows, which can include payments to vendors, rent/mortgage payments, utilities payments, payroll payments, taxes, etc. Each of the outflows can be associated with different forms of payment, timelines (e.g., dates and/or times) for payment, payment terms, etc. In some cases, the source and the form of payment can be the same. Techniques described herein can automate payment processes and can utilize machine-trained model(s) to add intelligence to such automation. That is, techniques described herein can leverage data associated with the service provider—that is generated and/or availed via a distributed, network-connected environment comprising multiple end users (e.g., payors, payees, etc.) and a centralized service provider—to train model(s) that can be used to determine optimal payment mechanism(s) for one or more electronic records. In some examples, such model(s) can be trained using machine-learning mechanisms. In some examples, such model(s) can be used to intelligently determine a form of payment and/or a payment duration for payment of individual electronic records. Techniques described herein therefore reduce the number of interactions between a payor and a user computing device and therefore provide a streamlined, improved user experience for payors.

As described herein, techniques described herein enable the use of rules to make decisions with respect to which payment methods and/or associated rails to use for particular transactions and/or timing associated therewith. In some examples, payors can designate preferences and/or other rules for handling payment of electronic records and transactions associated therewith. In some examples, the service provider can utilize such rules for determining when to pay a particular electronic record and/or a form of payment for paying the particular electronic record. In some examples, such rules can be used as training data for training model(s) as described herein. Such rules can be used to improve and/or automate payments and associated technologies, as described herein.

For example, techniques described herein can settle payments associated with electronic records using funds managed by the service provider (e.g., stored balances and/or credit balances), which may or may not require the use of conventional payment rails. For example, if a payee accepts credit cards (e.g., external to the service provider), techniques described herein may opt to utilize a credit card to settle a payment associated with an electronic record of the payee (e.g., and the payee may bear the cost of the transaction). In some examples, if the payee does not accept credit cards and the payor indicates a strong preference or requests to pay by credit card, techniques described herein may opt to utilize the credit card and pass the transaction fee on to the payor. In some examples, if the payee does not accept credit cards and the payor does not want to pay via credit card (e.g., the payor does not want to incur the additional cost), techniques described herein can utilize the stored balance of the payor or a transfer from a linked bank account of the payor and can settle the payment using an ACH or other electronic funds transfer, check, cryptocurrency, peer-to-peer, real-time (e.g., payments using “Real-Time Payment” (RTP) network infrastructure, or other similar infrastructure, that provides consumers and businesses with the ability to send payments directly from their accounts at federally insured depository institutions 24/7, and to receive and access funds sent to them over the RTP network immediately, payments made over instant clearing and/or settlement rails, etc.), and/or the like. In some examples, if the payor opts to use credit offered by service provider (e.g., accepts a credit offer from the service provider), techniques described herein can increase the credit balance of the payor and settle payment via an ACH or other electronic funds transfer, check, cryptocurrency, peer-to-peer, real-time (non-peer-to-peer), and/or the like. In some examples, a payment instrument associated with the stored balance or credit balance can be used for making a payment for the payor, and in such examples, traditional transaction fees (e.g., associated with the card rails) can be associated with the transaction. In some examples, payment can be made, by the service provider, to the payee in a preferred form of the payee, and funds from a funding source of the payor, such as a peer-to-peer balance, a stored balance, a cryptocurrency balance, and/or the like can be used for settling payment between the payor and the service provider. In some examples, techniques described herein can utilize rules and/or machine-trained models that take into account transaction characteristics, payor characteristics of the payor, and/or payee characteristics of the payee to determine (i) whether to use traditional payment rails (or utilize funds availed via the service provider) and/or (ii) which payment rails to use for individual transactions. In such examples, techniques described herein can determine whether to use such payment rails and/or which payment rails to use in a “dynamic” fashion, on a per transaction or per electronic record basis.

In addition, techniques described herein utilize data that is not conventionally available for decision-making with respect to payment optimization, as described herein. That is, by providing services over a distributed, network-connected environment, techniques described herein can access and utilize data that allows such decision-making to be more accurate. Furthermore, techniques described herein can utilize network-wide data to make intelligent decisions, like those described above. Network-level information can be used to streamline onboarding and/or optimize payments (e.g., negotiate better terms, batch transfers, etc.), thereby reducing the number of interactions between users and respective computing devices. To the extent techniques described herein utilize network-level information to determine optimal timing and/or forms of payment, techniques described herein can reduce network traffic and/or congestion (e.g., by making batch payments or the like). In some examples, network-level information can additionally or alternatively be used for negotiating payment terms and/or methods with payees and streamlining payments with such payees.

In at least one example, techniques described herein provide standardization of electronic records received via a user interface for determining how and/or when to remit payment for such electronic records to remote payees via a network. That is, techniques described herein enable payors to provide electronic records (e.g., invoices, bills, and/or other electronic records requesting payment) to a service provider. In some examples, such electronic records can be in different formats and/or be associated with different data. In at least one example, the service provider can provide a user interface for payors to manually input data associated with a physical record or electronic record that is not ingestible by the service provider. The service provider can ingest electronic records and/or receive data associated with other records (e.g., over a network) and can convert the records into a standardized format. As such, techniques described herein enable remotely located users to upload and/or otherwise provide electronic records in real-time, which can be standardized for payment optimization described herein. The standardized electronic records can then be processed and/or analyzed—for example using machine-trained model(s)—to determine optimal payment mechanism(s) for individual of the standardized electronic records. In at least one example, such ingested and standardized data can be converted into formats that are particular to a payee for payment. That is, in some examples, the service provider can convert the ingested and standardized data into a different format that is particular to a payee for remitting payment for a particular electronic record.

As described above, the service provider described herein can offer various services (e.g., intelligent electronic record management services, payment processing services, payroll services, invoicing services, peer-to-peer payment services, lending services, and/or the like). The service provider can receive and/or determine data associated with individual of the services used by individual of the payors. The service provider can therefore utilize such data, including payments made on behalf of payors, as described herein, to account, or otherwise track, cashflow for such payors in real-time. That is, as a centralized service provider offering services to various end users over a network, the service provider has access to data that other service providers does not. Such data can be useful for tracking inflow and outflow of cash of payors using such services. As such, techniques described herein enable centralization of electronic record payment for payors that can enable individual payors to have real-time up-to-date cash flow information. This provides an improvement over existing electronic record management technology.

In addition to providing centralization and/or optimization of electronic record payment for payors, techniques described herein can provide centralization and/or optimization of electronic record management for payees. That is, techniques described herein can be utilized by payees for determining optimal payment mechanisms for requesting payment and/or otherwise managing electronic records.

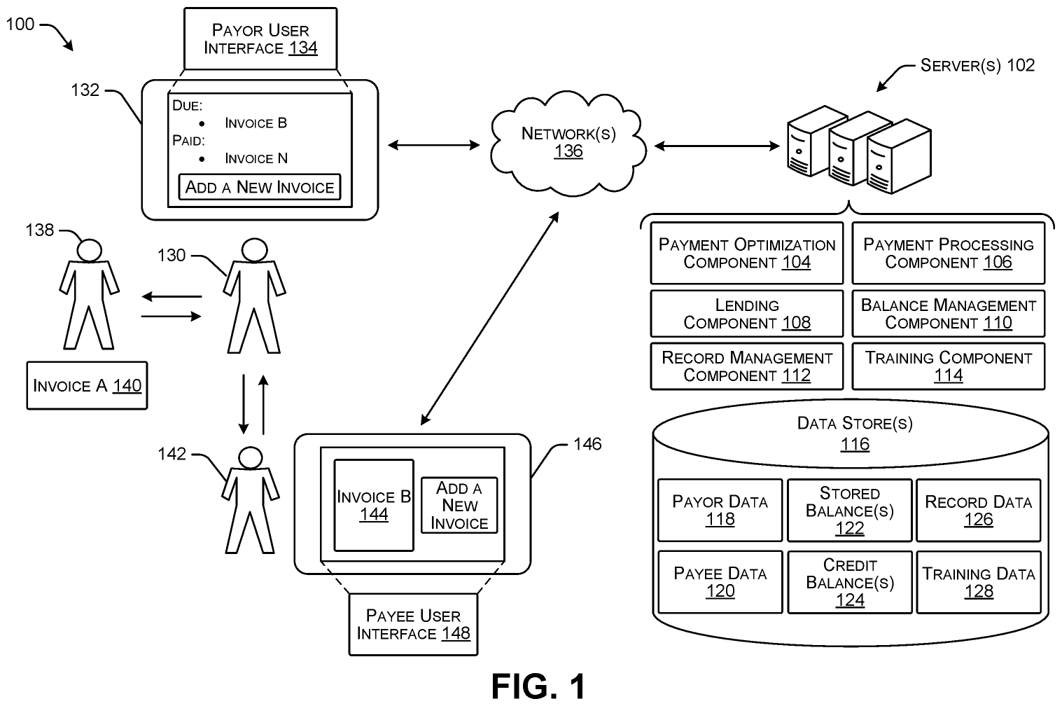

FIG. 1 illustrates an example environment 100 for performing techniques described herein. In an example, the environment 100 can include one or more computing devices, which can be server(s) 102, associated with a service provider. The service provider can provide intelligent electronic record management services, payment processing services, payroll services, invoicing services, peer-to-peer payment services, lending services, and/or the like, for one or more payors, payees, and/or other users. In at least one example, the server(s) 102 can be associated with one or more functional components that are configured to perform one or more operations associated with the one or more services provided by the service provider. For example, as illustrated in FIG. 1, the server(s) 102 can include a payment optimization component 104 for facilitating intelligent electronic record management services, a payment processing component 106 for facilitating payment processing services, a lending component 108 for facilitating lending services, a balance management component 110 for facilitating, in part, a peer-to-peer payment services and/or otherwise managing balances associated with the service provider, a record management component 112 for facilitating record generation and/or management services, associated with invoices, estimates, bills, and/or the like.

In at least one example, the payment optimization component 104 can receive electronic records (e.g., invoices, bills, and/or other electronic records requesting payment), process the electronic records, determine optimal payment mechanisms associated with individual of the electronic records, and settle payments associated therewith. Additional details are provided herein.

The payment processing component 106 can receive transaction data associated with transactions and utilize payment data associated therewith to process payment for the transactions. In some examples, the payment processing component 106 can communicate with a point-of-sale application on a computing device of a merchant (which, in some examples can be a payor as described herein) and one or more third-party payment services, such as acquiring banks (“acquirer”), issuing banks (“issuer”), card payment networks, and/or the like. That is, the payment processing component 106 can configure the service provider as an intermediary payment processor. In some examples, proceeds from payments processed by the payment processing component 106 can be associated with stored balances, as described herein, and/or can be used for repayment of credit balances, as described herein. Additional details are provided below.

The lending component 108 can generate offers for credit and/or other lending products, send such offers to relevant entities, and manage issuance and/or repayment of such credit and/or other lending products. In some examples, the lending component 108 can make a real-time lending decision based on signals about the payor (e.g., based on payor data and/or other indications of creditworthiness and/or risk), signals about the payee, data associated with electronic record(s), or lending decisions can be based on a pre-determined credit limit that can be updated periodically. In an example, “just-in-time” credit decisions can also factor in the most up-to-date payor data as well as data specific to a particular payee and/or an associated electronic record/transaction. In some examples, offers for credit can be presented to payors prior to transactions, at points-of-sale, or after transactions. In some examples, offers for credit can be presented to payors in response to a determination, by the payment optimization component 104, that credit is an optimal payment mechanism for a particular electronic record. Furthermore, in some examples, data related to making credit/lending decisions can additionally/alternatively be used to prevent fraudulent payments (e.g., based on patterns, transaction amount, etc.) and/or, as described below, for determining optimal payment mechanisms.

The balance management component 110 can manage balances such as a stored balance and/or a credit balance, both of which are described in more detail below. In some examples, stored balances can be generated based at least in part on proceeds of payment(s) processed by the service provider on behalf of the payor (e.g., via a payment processing service), peer-to-peer payment(s) received by the service provider on behalf of the payor (e.g., via a peer-to-peer payment service), receivables from invoice(s) invoiced by the service provider on behalf of the payor (e.g., via an invoicing service), and/or the like. The balance management component 110 can add or subtract values from the stored balances based on such incoming (or outgoing) funds. In some examples, the balance management component 110 can additionally or alternatively manage credit balances, as described herein.

The record management component 112 can generate invoices and/or manage payment of such invoices for merchants (which, in some examples, can be payees as described herein).

While five functional components are illustrated in FIG. 1, the server(s) 102 can have any number of functional components that can be used for facilitating service(s) availed by the service provider. In some examples, a single functional component can be used for facilitating multiple service(s) and/or multiple functional components can be used for facilitating a single service. Additional details associated with individual of the functional components are provided below.

In addition to the functional components associated with individual services, the server(s) 102 can be associated with a training component 114. In at least one example, the training component 114 can train models, using machine learning mechanisms. In some examples, the training component 114 can utilize data stored in data store(s) 116 associated with the server(s) 102 for training such model(s). Examples of such data include payor data of payor(s) associated with the service provider and/or record data associated with electronic records received and/or processed by the service provider. For example, the training component 114 can train the model(s) based at least in part on training data indicating due dates associated with payment of the electronic records, payment terms associated with payment of the electronic records, preferred forms of payment for payment of the electronic records, fees associated with payment of the electronic records, incentives associated with payment of the electronic records, payor data, credit signals and/or risk signals of payors, etc. In at least one example, the training component 114 can utilize one or more machine learning mechanisms to train one or more models to output recommendations for payment that can be optimal for a particular payor and/or electronic record (e.g., an “optimal payment mechanism”). In at least one example, such an output can include a form of payment, a date and/or time of payment, and/or the like. Additional details are provided below.

In at least one example, the server(s) 102 can be associated with data store(s) 116, which can store data associated with the service provider. In some examples, the data store(s) 116 can be integrated in the server(s) 102. In some examples, the data store(s) 116 can be remotely located from the server(s) 102 and accessible to the server(s) 102. In some examples, the data store(s) 116 can store payor data 118, payee data 120, stored balance(s) 122, credit balance(s) 124, record data 126, and/or training data 128. The data store(s) 116 can store additional or alternative data.

Payor data 118 can comprise data associated with payor(s) that utilize services of the service provider for paying invoices, bills, and/or other electronic records requesting payment. In at least one example, the payor data 118 can include paid electronic records where associated payments are settled, outstanding electronic records where associated payments are not yet settled, past due electronic records where associated payments have not yet been settled and are past a due date for payment, and/or the like. In some examples, the payor data 118 can indicate forms of payment available to a payor (e.g., check, ACH or wire transfer (e.g., from a stored balance or other source of funds), credit card(s), debit card(s), linked bank account(s), cryptocurrency, peer-to-peer, real-time, loyalty reward(s), etc.), preferred forms of payment, previously used forms of payment, etc. In some examples, the payor data 118 can indicate a history of payments made by the payor, which can include indications of payees, dates payments were made, form(s) of payment used, timeliness of such payments (e.g., early, on time, late, etc.), fees assessed for particular payments, incentives/rewards earned for particular payments, etc. The payor data 118 can include information associated with payors, such as which service(s) of the service provider are used by a payor, name of the payor, business information associated with the payor, linked bank account information associated with the payor, stored balance(s) associated with the payor, credit balance(s) associated with the payor, credit signals associated with the payor, fraud signals associated with the payor, linked third-party data (e.g., FICO scores, etc.), etc. In some examples, data associated with other services used by a payor can be mapped to, or otherwise associated with, the payor data 118.

Payee data 120 can comprise data associated with payee(s) that receive payment via services of the service provider. The payee data 120 can include information associated with payees, such as which service(s) of the service provider are used by a payee, name of the payee, business information associated with the payee, bank account information associated with the payee, stored balance(s) associated with the payee, credit balance(s) associated with the payee, etc. In some examples, electronic records associated with the payee can be stored in the payee data 120. Such electronic records can include paid electronic records where associated payments are settled, outstanding electronic records where associated payments are not yet settled, past due electronic records where associated payments have not yet been settled and are past a due date for payment, and/or the like. In some examples, the payee data 120 can indicate forms of payment accepted by a payee (e.g., checks, ACH or wire transfers (e.g., from a stored balance or other source of funds), credit card(s), debit card(s), linked bank account(s), cryptocurrency, peer-to-peer, real-time, loyalty reward(s), etc.), preferred forms of payment, etc. In some examples, the payee data 120 can indicate a history of payments made to the payee, which can include indications of payors, dates payments were made, form(s) of payment used, timeliness of such payments (e.g., early, on time, late, etc.), fees assessed for particular payments, incentives/rewards provided for particular payments, etc.

Stored balance(s) 122 can comprise data associated with one or more stored balances that are managed by the service provider. As described above, a stored balance of a payor can be generated based at least in part on proceeds of payment(s) processed by the service provider on behalf of a payor, peer-to-peer payment(s) received by the service provider on behalf of the payor, receivables from invoice(s) invoiced by the service provider on behalf of the payor, and/or the like. In some examples, a portion of the stored balance can be used to pay an invoice, bill, and/or other electronic record, pay payroll, make a peer-to-peer payment, etc. For example, funds associated with a stored balance can be transferred to another stored balance or bank account via a funds transfer such as an ACH transfer, wire transfer, or the like. In some examples, the stored balance can be transferred into a linked bank account of a payor. In some examples, a payment instrument associated with the stored balance can be used to pay an invoice, bill, and/or other electronic record, make purchases, and/or the like.

In at least one example, transactions associated with a stored balance can be logged or otherwise tracked in a transaction history associated with the stored balance. Such a transaction history can indicate previous transactions associated with the stored balance and/or payment instrument associated therewith. In some examples, payments for electronic records, such as invoice payments, bill payments, etc., can be represented as a transaction in the transaction history of the stored balance. That is, the transaction history of the stored balance can represent transactions that utilize stored funds managed by the service provider in association with one or more services and/or products (e.g., a service provider payment instrument linked to the stored balance, electronic records paid using stored balance funds, and/or the like).

Credit balance(s) 124 can comprise data associated with one or more credit balances that are managed by the service provider. As described above, the lending component 108 can generate credit offers. In some examples, terms of such credit offers can be determined based at least in part on payor data and/or other data indicative of creditworthiness or risk of payors. That is, the lending component 108 can determine a credit signal and/or risk signal associated with a payor (or other offeree) and can determine terms of a credit offer based at least in part on the credit signal and/or risk signal. Such terms can include time for repayment, acceptable forms of repayment, fees associated with the credit offer, late fees associated with late repayment, and/or the like. In at least one example, the lending component 108 can send the credit offer to a payor and based at least in part on the payor accepting the credit offer, the lending component 108 can generate and/or add an amount of the credit offer to a credit balance associated with the payor. The credit balance can be repaid using proceeds of payment(s) processed by the service provider on behalf of the payor, peer-to-peer payment(s) received by the service provider on behalf of the payor, receivables from invoice(s) invoiced by the service provider on behalf of the payor, payments made by the payor (e.g., from a linked bank account, etc.), and/or the like. The lending component 108 can manage repayment of the credit balance. In some examples, the timeline for repayment of a credit balance can be agnostic to the due date of payments settled using credit associated with the credit balance. That is, in some examples, using credit, as described herein, can extend the timeline for payors to make payments (e.g., beyond due dates associated therewith).

In at least one example, transactions associated with a credit balance can be logged or otherwise tracked in a transaction history associated with the credit balance. Such a transaction history can indicate previous transactions associated with the credit balance and/or payment instrument associated therewith. In some examples, payments for electronic records, such as invoice payments, bill payments, etc., can be represented as a transaction in the transaction history of the credit balance. That is, the transaction history of the credit balance can represent transactions that utilize credit funds provided by the service provider in association with one or more services and/or products (e.g., a service provider payment instrument linked to the credit balance, accepted credit offers, and/or the like).

The record data 126 can comprise data associated with one or more electronic records. In at least one example, an electronic record can be associated with a payee, an amount to be paid by the payor, a due date for payment, acceptable form(s) of payment, a preferred form of payment, terms of payment (e.g., late fees, incentives for early payment, etc.), etc. In some examples, the record data 126 can indicate whether payment associated with an electronic record has been made and/or settled (e.g., a status associated therewith), the form of payment, the date of the payment, and/or the like. In some examples, the record data 126 can indicate statuses of the electronic records (e.g., paid, outstanding, late, etc.). The record data 126 can refer to aggregated record data of electronic records. In some examples, each electronic record can be associated with a portion of record data that is particular to the electronic record (e.g., a payee, an amount to be paid by the payor, a due date for payment, acceptable form(s) of payment, a preferred form of payment, terms of payment (e.g., late fees, incentives for early payment, etc.), etc.). In some examples, the payment optimization component 104 can receive electronic records of different formats and convert them into a standardized format for storing in the record data 126. Additional details are described below.

The training data 128 can comprise data used for training the model(s), as described above. In some examples, the training data 128 can comprise at least a portion of the payor data 118, the record data 126, and/or the like. As described above, the training data 128 can include due dates associated with payment of the electronic records, payment terms associated with payment of the electronic records, preferred forms of payment for payment of the electronic records, fees associated with payment of the electronic records, incentives associated with payment of the electronic records, payor data, credit signals and/or risk signals, etc.

In at least one example, payors and/or payees can use services of the service provider. In some examples, a payor 130 can be associated with a computing device, a payor computing device 132, which can present a payor user interface 134 to enable the payor 130 to access and/or use services of the service provider. In some examples, the payor user interface 134 can be presented via a web browser, an application provided by the service provider, and/or the like. In some examples, the payor user interface 134 can be presented via a user-facing application, such as a buyer application, a peer-to-peer payment application, a payment application, and/or the like that can be associated with the service provider. For example, a peer-to-peer payment application can allow integration of electronic records, credit, stored balance, and/or the like and can enable a user to control each via the application. In some examples, payments can be represented in transaction history, which can represent other transactions of the user (e.g., brick-and-mortar, ecommerce, peer-to-peer payments, etc.).

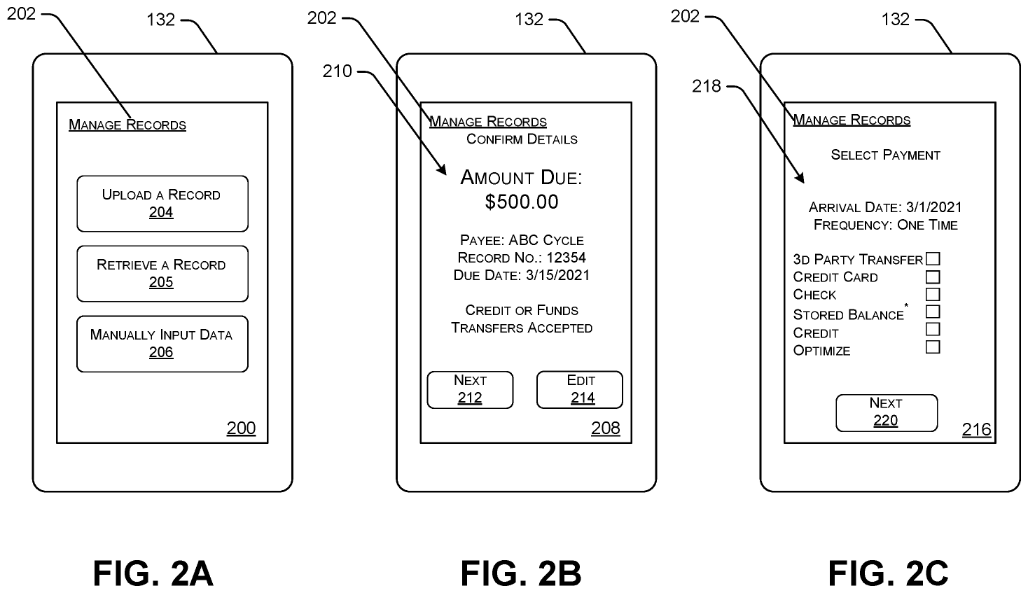

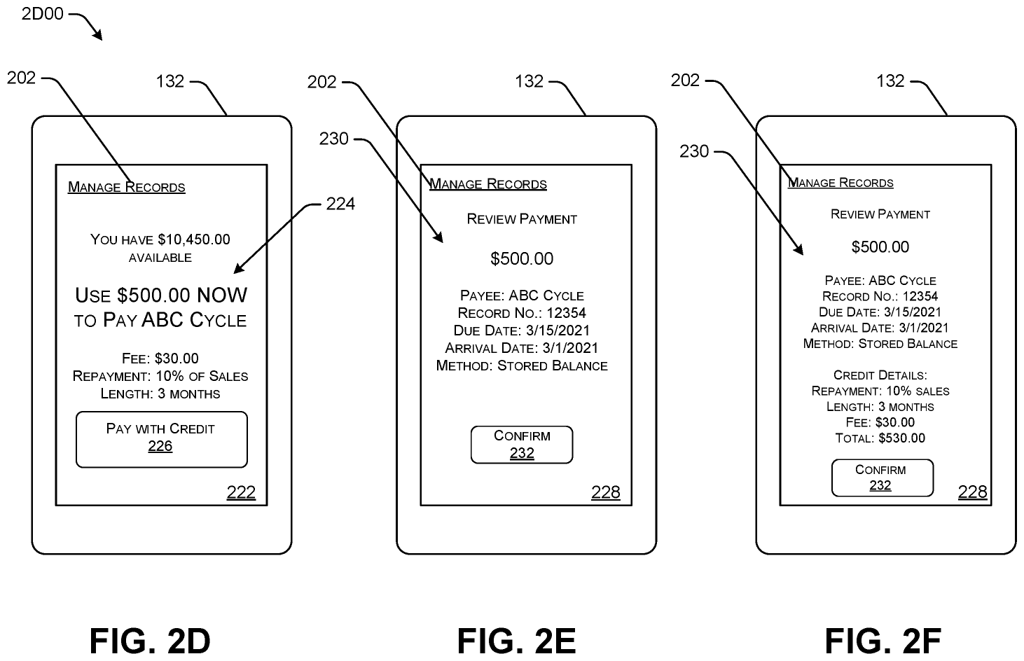

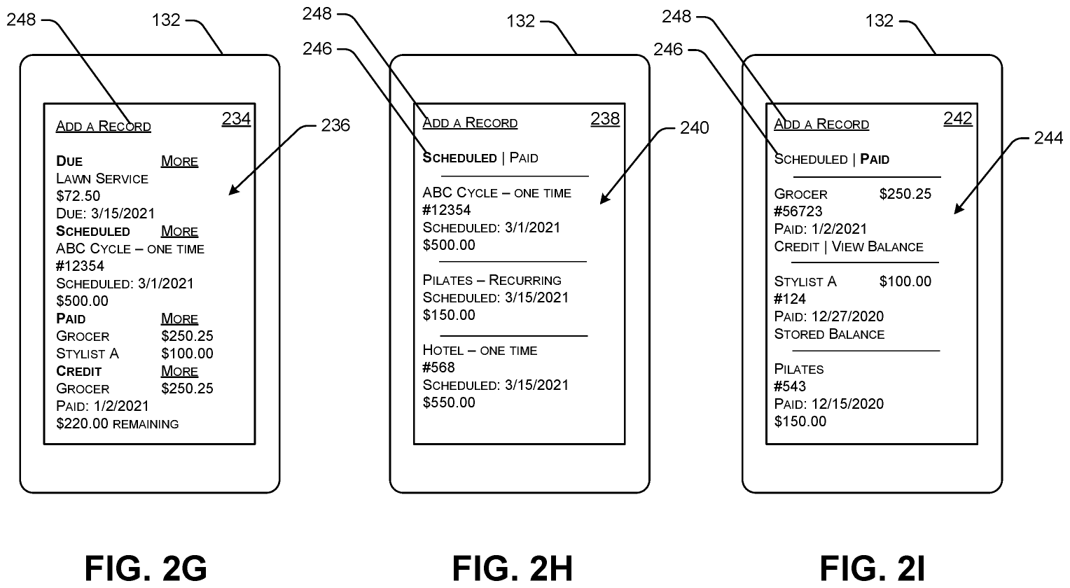

In some examples, the payor computing device 132 can be specially configured to present the payor user interface 134 and exchange communications with the server(s) 102 via one or more network(s) 136. In at least one example, the payor user interface 134 can present one or more graphical user interfaces to enable the payor 130 to upload and/or input information associated with new electronic records. In at least one example, the payor user interface 134 can present one or more graphical user interfaces to enable the payor 130 to view outstanding electronic records, past due electronic records, paid electronic records, etc. In some examples, the payor user interface 134 can present one or more graphical user interfaces to enable the payor 130 to view cash-flow information and/or other information associated with its business. Additional details associated with the payor user interface 134, and associated graphical user interface(s), are described below with reference to FIGS. 2A-2I. The payor user interface 134, however, can present additional or alternative data via additional or alternative user interfaces.

In at least one example, the payor can interact with one or more payees, for obtaining services and/or goods therefrom. Such an interaction can be associated with a record. In some examples, the record can be associated with a transaction and, in some examples, payment associated therewith. In FIG. 1, a first payee 138 is associated with a first record (i.e., Invoice A 140) and a second payee 142 is associated with a second record (i.e., Invoice B 144). In at least one example, the first record can be associated with a request for payment for goods and/or services rendered or otherwise provided by the first payee 138(A) to the payor 130. The first record can be an invoice, a bill, etc. In at least one example, the first record can be associated with record data indicating at least one of an amount to be paid by the payor 130 to the first payee 138, a due date for payment, acceptable forms of payment (e.g., cash, check, credit card, debit card, ACH transfer, wire transfer, cryptocurrency, peer-to-peer, real-time, etc.), fees associated with different forms of payment and/or late payments, incentives for early payment, a preferred form of payment, etc. In at least one example, the first record can be provided by the first payee 138 to the payor 130 directly instead of being provided to the service provider. In some examples, the first record can be sent to the payor computing device 132, for example via email, text message, etc. In such examples, the first record can be an electronic record. In some examples, the first record can be sent to the payor 130 via physical mail. In such examples, the first record can be a physical record.

In at least one example, when a physical record is provided to the payor 130, the payor 130 can manually input record data associated with the record via the payor user interface 134. For example, in at least one example, if the first record (e.g., the Invoice A 140) is a physical record, the payor 130 can interact with the payor user interface 134 to input record data associated with the first record. In such an example, the payor user interface 134 can generate a new electronic record based on the record data associated with the physical record. That is, the payor 130 can interact with the payor user interface 134 to generate an electronic record. In such an example, the payor user interface 134 can send the electronic record to the payment optimization component 104, which can store the electronic record in the record data 126. In some examples, the payor 130 can upload an electronic copy of the first record (e.g., via an image capture, scan, file upload, or the like). In such examples, the payor user interface 134 can forward or otherwise provide the first record to the server(s) 102. In some examples, the payor user interface 134 can receive the first record in an electronic format (e.g., from the first payee 138, as an email, text message, attachment, etc.) and can forward the first record, in the electronic format, to the server(s) 102.

In at least one example, when an electronic record is associated with a format that is different than the format in which record data 126 is stored by the service provider, the payment optimization component 104 can convert the electronic record to a standardized format in which the record can be stored in the record data 126. That is, in an example where the payor 130 uploads an electronic record that is in a format different than the standardized format and/or forwards an electronic record that is in a format different than the standardized format, the payment optimization component 104 can convert the electronic record to the standardized format. In some examples, the payment optimization component 104 can process the electronic record using image recognition, natural language processing, and/or other models for extracting or otherwise determining record data associated with the electronic record. In some examples, the payment optimization component 104 can generate a new electronic record associated with the extracted record data and can store the new electronic record in the record data 126. In such examples, the new electronic record can be in a standardized format for storing in the record data 126 and/or processing by the payment optimization component 104.

In at least one example, the second record can be associated with a request for payment for goods and/or services rendered or otherwise provided by the second payee 142 to the payor 130. The second record can be an invoice, a bill, etc. associated with goods and/or services rendered or otherwise provided by the second payee 142 to the payor 130. In at least one example, the second record can be associated with record data indicating at least one of an amount to be paid by the payor 130 to the second payee 142, a due date for payment, acceptable forms of payment (e.g., cash, check, credit card, debit card, ACH transfer, wire transfer, cryptocurrency, peer-to-peer, real-time, etc.), fees associated with different forms of payment and/or late payments, incentives for early payment, a preferred form of payment, etc. As an example, the second record can be provided, by the second payee 142, directly to the service provider, which, in some examples, can send the second record to the payor computing device 132. In such an example, the second record can be an electronic record. If the electronic record is in the standardized format, the payment optimization component 104 can receive the electronic record and store it in the record data 126. If the electronic record is not in the standardized format, the payment optimization component 104 can convert the electronic record into the standardized format as described above prior to storing it in the record data 126.

In some examples, payees can utilize services of the service provider, for example, for generating and/or managing invoices. In at least one example, the second payee 142 can be associated with a computing device, a payee computing device 146. The payee computing device 146 can present a payee user interface 148 to enable the second payee 142 to access and/or use services of the service provider. In some examples, the payee user interface 148 can be presented via a web browser, an application provided by the service provider, and/or the like. In at least one example, the payee user interface 148 can be presented via a user-facing application, such as a merchant application, a point-of-sale application, a peer-to-peer payment application, a payment application, and/or the like that can be associated with the service provider. For example, a peer-to-peer payment application can allow integration of electronic records, credit, stored balance, and/or the like and can enable a user to control each via the application. In some examples, payments can be represented in transaction history, which can represent other transactions of the user (e.g., brick-and-mortar, ecommerce, peer-to-peer payments, etc.).

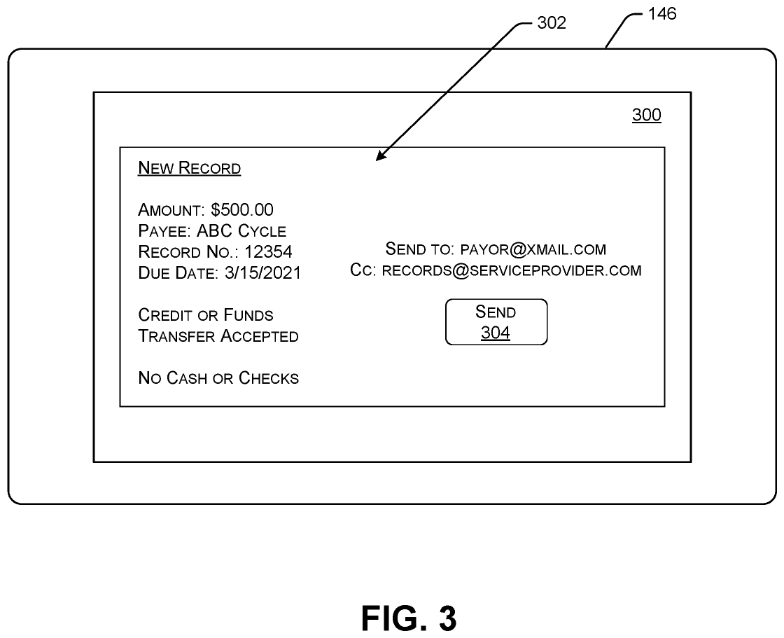

In some examples, the payee computing device 146 can be specially configured to present the payee user interface 148 and exchange communications with the server(s) 102 via one or more network(s) 136. In some examples, the payee user interface 148 can enable the second payee 142 to generate a new electronic record, view outstanding electronic records, view paid electronic records, and/or the like. In at least one example, the record management component 112 can receive requests to generate new electronic records, generate new electronic records, send the electronic records to relevant payors, and store such electronic records in the record data 126 of the data store(s) 116. In at least one example, the record management component 112 can manage and/or otherwise track payment of such electronic records. Additional details associated with the payee user interface 148 are described below with reference to FIG. 3.

In at least one example, the payment optimization component 104 can receive the first record and the second record. As described above, the payment optimization component 104 can determine whether the records are in a standardized format and, if either the first record or the second record is not in the standardized format, the payment optimization component 104 can convert the relevant record(s) into the standardized format. In at least one example, the payment optimization component 104 can process the electronic records to determine record data associated therewith. That is, the payment optimization component 104 can use image recognition, natural language processing, and/or other models for extracting or otherwise determining record data associated with each electronic record. In at least one example, the payment optimization component 104 can access payor data (e.g., of the payor data 118) associated with the payor 130 and can determine an optimal payment mechanism for settling payment for the first electronic record and settling payment for the second electronic record. In at least one example, the payment optimization component 104 can utilize one or more machine-trained models to determine (i) a first form of payment and a first date and/or time for making a payment associated with the first electronic record and (ii) a second form of payment and a second date and/or time for making a payment associated with the second electronic record. In some examples, an optimal payment mechanism can be associated with a preferred form of payment of the payor 130, a preferred form of payment of the payees (e.g., the first payee 138 or the second payee 142), a form of payment determined to provide a reward or other benefit to the payor 130, a form of payment determined to optimize cash flow of the payor 130, a form of payment determined to avoid a fee, and/or the like. In some examples, an optimal payment mechanism can be associated with a date and/or time that optimizes cash flow of the payor, avoids a fee, provides a reward, and/or the like. In some examples, an optimal payment mechanism can be associated with a date and/or time that optimizes payment for a respective payee. In some examples, such an optimal time for the respective payee can be “instant” (e.g., within a threshold period of time of receiving a record from the respective payee), “timely” (e.g., within the time allotted for payment), etc. As described above, in at least one example, “optimal” can refer to optimizing for cash flow (of the payor and/or payee), optimizing for time, optimizing for network constraints, optimizing for speed, optimizing for keeping the credit limited (for the payor and/or the payee), etc. In some examples, the subject of optimization (e.g., cash flow, time, network constraints, speed, credit limit, etc.) can be selected and/or adjusted based on a user interface element associated with a user interface (e.g., a scale, a slider, etc.).

In some examples, a first form of payment can be used to settle payment of the first electronic record. In at least one example, the first form of payment can be determined, by the payment optimization component 104, to be the optimal form of payment for the first electronic record. In some examples, the first form of payment can be associated with using a stored balance of the payor 130. In such examples, the payment optimization component 104 can determine a value of the stored balance of the payor 130 (e.g., via a query to the balance management component 110). So long as the value of the stored balance meets or exceeds the amount of the payment associated with the first electronic record, the payment optimization component 104 can transfer funds from the stored balance of the payor 130 to the first payee 138. That is, a portion of the stored balance of the payor 130 can be used to settle payment of the first electronic record. In some examples, the payment optimization component 104 can transfer such funds to a bank of the first payee 138, a stored balance of the first payee 138, or another indicated repository associated with the first payee 138. After the payment has been provided to the first payee 138, the balance management component 110 can reduce the value of the stored balance based at least in part on the amount of the payment. In some examples, the source of funds can be the stored balance of the payor 130 and the service provider can select the form of payment (e.g., a credit card, an ACH or other electronic funds transfer, a check, cryptocurrency, a peer-to-peer payment, a real-time payment, etc.) used by the service provider for paying the first payee 138. That is, in some examples, the payor 130 can be involved in selecting a source of funds for payment, but may not be involved in selecting a form of payment. In some examples, the form of payment and/or the source of payment can be determined by the payment optimization component 108, as described above.

In some examples, the second form of payment can be associated with the stored balance of the payor 130 or another form of payment. In at least one example, the second form of payment can be determined, by the payment optimization component 104, to be the optimal form of payment for the second electronic record. In some examples, a preferred form of payment for the second electronic record can be associated with the stored balance (e.g., a check, an electronic funds transfer, etc.). In such examples, so long as the value of the stored balance meets or exceeds the amount associated with the second electronic record, the payment optimization component 104 can transfer funds from the stored balance of the payor 130 to the second payee 142. That is, a portion of the stored balance of the payor 130 can be used to settle payment of the second electronic record. In some examples, the payment optimization component 104 can transfer such funds to a bank of the second payee 142, a stored balance of the second payee 142, or another indicated repository associated with the second payee 142. After the payment has been provided to the second payee 142, the balance management component 110 can reduce the value of the stored balance based at least in part on the amount of the payment. In some examples, the source of funds can be the stored balance of the payor 130 and the service provider can select the form of payment (e.g., a credit card, an ACH or other electronic funds transfer, a check, cryptocurrency, a peer-to-peer payment, a real-time payment, etc.) used by the service provider for paying the second payee 142. That is, in some examples, the payor 130 can be involved in selecting the source of funds but may not be involved in selecting the form of payment. In some examples, the form of payment can be determined by the payment optimization component 108.

In an example where the value of the stored balance is less than the amount of the payment associated with the second electronic record, the payment optimization component 104 can send an indication of such to the lending component 108. In some examples, the lending component 108 can access payor data, of the payor data 118, associated with the payor 130 and can generate a credit offer. In at least one example, terms of the credit offer can be determined based at least in part on the payor data associated with the payor 130, which can be indicative of creditworthiness and/or risk. In at least one example, the lending component 108 can send the credit offer to the payor computing device 132. In at least one example, based at least in part on the lending component 108 receiving an indication that the payor 130 accepts the credit offer, the lending component 108 can send an indication of such to the balance management component 110. The balance management component 110 can determine whether the payor 130 is associated with an existing credit balance and, if the payor 130 is associated with an existing credit balance (e.g., of the credit balance(s) 124), the balance management component 110 can add the amount of credit associated with the credit offer to the credit balance of the payor 130. If the payor 130 is not associated with a credit balance, the balance management component 110 can generate a new credit balance for the payor 130. In either example, the amount of the credit associated with the credit offer can be associated with a credit balance associated with the payor 130. The lending component 108 can manage repayment of the credit balance, which can be repaid using proceeds of payment(s) processed by the service provider on behalf of the payor 130, peer-to-peer payment(s) received by the service provider on behalf of the payor 130, receivables from invoice(s) invoiced by the service provider on behalf of the payor 130, payments made by the payor 130, and/or the like. In some examples, a credit offer can be generated and/or provided to the payor 130 prior to determining whether the optimal payment mechanism is associated with the stored balance. That is, in some examples, credit offers can be generated prior to a determination of an optimal payment mechanism or in response to a determination that credit is the optimal payment mechanism.

In some examples, based at least in part on the payor 130 accepting the credit offer, the payment optimization component 104 can cause a payment for an amount associated with the second electronic record to be sent to the second payee 142. That is, in some examples, acceptance of the credit offer, by the payor 130, can trigger settlement of the payment associated with the second electronic record. In some examples, the payment can be in a preferred form of the second payee 142. In some examples, the payment can be in a preferred form of the payor 130. In some examples, the payment can be in a recommended form as determined by the payment optimization component 104. That is, the payor 130 may accept the credit offer and may not be involved in the decision making regarding how the payment is made to the second payee 142. In some examples, the payment optimization component 104 can settle the payment via a credit card, an ACH or other electronic funds transfer, a check, cryptocurrency, a peer-to-peer payment, a real-time payment, etc. without the payor 130 selecting which form of payment is used by the service provider for paying the second payee 142. In some examples, some portion of the payment can be sourced from the stored balance while another one or more portions are sourced through other sources of funds (e.g., credit, cryptocurrency, peer-to-peer, etc.). In some examples, the payor 130 can set how much credit they would want to borrow per transaction or per month to allow the payor 130 to control the credit liabilities. Here, the payor 130 can be involved in selecting the source of the funds used for payment (e.g., credit vs. stored balance or other) but may not be involved in the selection of the form of payment (e.g., a credit card, an ACH or other electronic funds transfer, a check, cryptocurrency, a peer-to-peer payment, a real-time payment, etc.) used by the service provider for paying the second payee 142.

In some examples, settlements using a stored balance of the payor 130 and/or a credit balance of the payor 130 may or may not utilize traditional payment rails. For example, if the second payee 142 accepts credit cards (e.g., external to the service provider), the payment optimization component 104 may opt to utilize a credit card to settle a payment associated with the second electronic record (e.g., and the second payee 142 may bear the cost of the transaction). In some examples, if the second payee 142 accepts credit cards but the payor 130 does not have a credit card on file or has a preference to use another source of funds, the payment optimization component 104 may opt to use the preferred source of funds of the payor 130 and use a credit card (e.g., issued by the service provider or in the name of the service provider) to settle the payment to accrue a benefit to the service provider and/or the payor 130. In some examples, if the second payee 142 does not accept credit cards and the payor 130 indicates a strong preference or requests to pay by credit card, the payment optimization component 104 may opt to utilize the credit card and pass the transaction fee on to the payor 130. In some examples, if the second payee 142 does not accept credit cards and the payor 130 does not want to pay via credit card (e.g., the payor 130 does not want to incur the additional cost), the payment optimization component 104 can utilize the stored balance of the payor 130 or a transfer from a linked bank account of the payor 130 and can settle the payment using an ACH or other electronic funds transfer, check, cryptocurrency, peer-to-peer, real-time, and/or the like. In some examples, if the payor 130 opts to use credit offered by the lending component 108 (e.g., accepts a credit offer from the payor 130), the lending component 108 can increase the credit balance of the payor 130 and settle payment via an ACH or other electronic funds transfer, check, cryptocurrency, peer-to-peer, real-time, and/or the like. In some examples, a payment instrument associated with the stored balance or credit balance can be used for making a payment for the payor 130, and in such examples, traditional transaction fees (e.g., associated with the card rails) can be associated with the transaction. In some examples, the payment optimization component 104 can utilize rules and/or machine-trained models that take into account transaction characteristics, payor characteristics of the payor 130, and/or payee characteristics (e.g., of the second payee 142) to determine (i) whether to use traditional payment rails (or utilize funds availed via the service provider) and/or (ii) which payment rails to use for individual transactions. In such examples, the payment optimization component 104 can determine whether to use such payment rails and/or which payment rails to use in a “dynamic” fashion, on a per transaction or per electronic record basis.

In at least one example, the payor user interface 134 and/or the payee user interface 148 can be updated based at least in part on payments associated with the first electronic record and the second electronic record. Additional details associated with the user interfaces are described below with reference to FIGS. 2A-2I and 3.

FIGS. 2A-2I illustrate example graphical user interfaces that can be presented via the payor user interface 134, as described herein. In at least one example, a first graphical user interface 200 can include one or more user interface elements (e.g., text elements, graphical elements, images, or any other object) that, in some examples, can be actuated, or otherwise selectable, by the payor 130 to provide an input to the graphical user interface 200. In at least one example, a first user interface element 202 can enable the payor 130 to access electronic records and/or data associated therewith. In some examples, the first user interface element 202 can be associated with an actuation mechanism that, when actuated, can cause a different graphical user interface, pop-up, overlay, or the like to be presented. Additional details are described below.

In at least one example, the graphical user interface 200 can include a second user interface element 204 that can be associated with an actuation mechanism. When actuated, the graphical user interface 200 can be updated to enable the payor 130 to upload a record. In some examples, actuation of the second user interface element 204, when detected, can trigger activation of a scanner functionality, a camera functionality, and/or the like. Such functionality can be native to an application presenting the graphical user interface 200 or integrated into the application and/or web browser presenting the graphical user interface 200. In some examples, a file can be uploaded from another location on the payor computing device 132. In some example, based at least in part on a record being uploaded, the payor user interface 134 can send the electronic record to the server(s) 102. In some examples, actuation of the second user interface element 204 can be associated with an API connection, which can provide access to third-party service providers and/or the service provider for access to a record for uploading. In some examples, responsive to detecting actuation of the second user interface element 204 another user interface or a pop-up, overlay, or the like can be presented to enable the payor 130 to select a record for uploading.

In at least one example, the graphical user interface 200 can include a third user interface element 205 that can be associated with an actuation mechanism. Actuation of the the graphical user interface element 205 can initiate retrieval of one or more records via one or more API connections. In some examples, the one or more API connections can access records associated with third-party service providers and/or the service provider. In some examples, a subset of all available electronic records can be retrieved based at least in part on actuation of the actuation mechanism associated with the third user interface element 205. For example, contextually relevant records (e.g., due to be paid urgently, overdue, payee specific, etc.) can be retrieved prior to other, less relevant records.

In at least one example, the graphical user interface 200 can include a fourth user interface element 206 that can be associated with an actuation mechanism. When actuated, the graphical user interface 200 can be updated to enable the payor 130 to manually input record data associated with a record. As described above, in at least one example, such record data can be used to generate a new electronic record which can be sent to the server(s) 102 (via the payor user interface 134).

As described above, the electronic record can be sent to the server(s) 102. In at least one example, the payment optimization component 104 can receive the electronic record and determine whether the electronic record is in the standardized format for storing and/or processing. Based at least in part on a determination that the electronic record is not in the standardized format, the payment optimization component 104 can convert the electronic record into such a format, as described above. In at least one example, the payment optimization component 104 can analyze the electronic record to extract record data associated therewith. In at least one example, based at least in part on extracting the record data, the payment optimization component 104 can cause a new graphical user interface to be presented via the payor user interface 134 and/or can update the payor user interface 134 to present data described in FIG. 2B.

FIG. 2B illustrates an example of a graphical user interface 208 that can present user interface elements 210 representative of record data associated with the record uploaded and/or manually entered via the graphical user interface 200. In at least one example, the graphical user interface 208 can present record data indicating an amount due, the payee, the record number, the due date, forms of payment accepted (e.g., credit or electronic funds transfers), etc. In at least one example, the graphical user interface 208 can include a user interface element 212 that can be associated with an actuation mechanism. The user interface element 212 can enable the payor 130 to provide an input to confirm the information presented via the graphical user interface 208 is correct. In at least one example, a detected input associated with the user interface element 212 can cause an indication of confirmation to be sent to the server(s) 102. The graphical user interface 208 can include another user interface element 214 that can be associated with an actuation mechanism. The user interface element 214 can enable the payor 130 to provide an input that the information presented via the graphical user interface 208 is not correct. In at least one example, a detected input associated with the user interface element 214 can cause another graphical user interface, a pop-up, overlay, or the like to be presented for the payor 130 to correct the information. In at least one example, an indication that the information is incorrect and/or the corrected information can be sent to the server(s) 102. The graphical user interface 208 can include the user interface element 202 to enable the payor 130 to navigate to another graphical user interface and/or access alternative data as described above.

In at least one example, based at least in part on receiving confirmation or correction of the record data, the payment optimization component 104 can cause a new graphical user interface to be presented via the payor user interface 134 and/or can update the payor user interface 134 to present data described in FIG. 2C. In some examples, as described above electronic records can be provided to the service provider via other service(s) of the service provider (e.g., invoices, payroll, etc.) and/or via API(s) connected to the service provider. That is, as described above, the service provider can receive electronic records via sources other than via a manual upload or scan, as described in FIG. 2A.

FIG. 2C illustrates a graphical user interface 216 that can present user interface elements 218 associated with payment. The user interface elements 218 can indicate an arrival date (e.g., date payment is to be made or otherwise arrive in the account of the payee), a frequency associated with the payment (e.g., one time, recurring, etc.), optional forms of payment, and/or the like. In at least one example, the optional forms of payment can be determined based at least in part on the forms of payment accepted by the payee, forms of payment available by the service provider, forms of payment available to the payor 130, and/or the like. In some examples, individual forms of payment can be associated with an incentive (as indicated by the symbol (*) associated with the stored balance) to incentivize the payor 130 to select the corresponding form of payment. Such an incentive can be a reward, a discount, a boost, or provide some other benefit to the payor 130. In some examples, different forms of payment can be associated with different fees and/or costs to the payor 130. For example, processing a payment using a third-party transfer (e.g., from a linked account managed by a third-party) can incur more fees to the service provider than using the stored balance managed by the service provider, which can be, in some examples, passed on to the payor 130. In some examples, such fees can be displayed via the graphical user interface 216. In some examples, the graphical user interface 216 can include a slider, scale, or the like, which can enable the payor 130 to specify amounts to take out of different sources of funds and/or limitations on amounts to be withdrawn from different sources and/or credit. In some examples, where the service provider automatically optimizes settlement of payments associated with records received, the graphical user interface 216 may not be presented to the payor 130 and a graphical user interface that confirms payment may be presented to the payor 130. An example of such a graphical user interface is described below with reference to FIG. 2E. It yet additional or alternative examples, when the service provider is authorized (e.g., by the payor 130) to optimize settlement of payments associated with records automatically (e.g., without further input from the payor 130), the payment optimization component 108 can determine optimal payment mechanisms and settle payments based on such determinations without confirmation from the payor 130. In such an example, neither the graphical user interface 216 nor the graphical user interface described below in FIG. 2E may be presented and an indication of the payment can be presented via a summary graphical user interface as described below.

In some examples, a payment option can include “credit,” which can trigger a request for a credit offer for the payor 130 and/or acceptance of a credit offer previously presented or availed to the payor 130. In some examples, such an option may not be presented if a credit offer has not already been generated. In some examples, a payment option can include an “optimization” option, which can provide an indication that the service provider can determine the optimal form of payment. In at least one example, the graphical user interface 216 can include a user interface element 220 associated with an actuation mechanism to enable the payor 130 to confirm payment details. In at least one example, an input detected in association with the user interface element 220 can cause an indication of the payment details to be sent to the server(s) 102. The graphical user interface 216 can include the user interface element 202 to enable the payor 130 to navigate to another graphical user interface and/or access alternative data as described above.

In at least one example, based at least in part on receiving payment details for payment associated with the electronic record, the payment optimization component 104 can cause a new graphical user interface to be presented via the payor user interface 134 and/or can update the payor user interface 134 to present data described below. It should be noted that while FIG. 2C illustrates different options that the payor 130 can select for payment, in some examples, a selection of such a payment (e.g., an input associated therewith) can indicate a selection of a source of funds and, in some examples, the service provider can use the selected source of funds as the form of payment to the payee or another form of payments to the payee, as described herein. For example, the payor 130 can opt to use the stored balance but the service provider can settle payment using a credit card or cryptocurrency. In some examples, the form (and/or timing) of payment can be based at least in part on the optimal payment mechanism recommended by the payment optimization component 104. In some examples, the payor 130 may be aware of the form (and/or timing) of payment used to settle the payment associated with the electronic record. In some examples, the payor 130 may not be aware of the form (and/or timing) of payment used to settle the payment associated with the electronic record.

FIG. 2D illustrates an example graphical user interface 222 associated with a credit offer being presented to the payor 130. In some examples, the lending component 108 can generate a credit offer for the payor 130. In some examples, such a credit offer can be generated in response to a determination that the stored balance of the payor 130 is insufficient to satisfy payment associated with the electronic record. In some examples, such a credit offer can be generated in response to a request from the payor 130. In at least one example, the graphical user interface 222 can indicate an amount of credit available to the payor 130 and/or repayment terms, which can be represented by one or more user interface elements 224, and can include a user interface element 226 that can enable the payor 130 to opt to pay with credit. In some examples, the user interface element 226 can be associated with an actuation mechanism that, when actuated, can cause the payor user interface 134 to send an indication of such to the server(s) 102. Actuation of the actuation mechanism associated with the user interface element 226 can indicate acceptance of the terms of the credit offer. Based at least in part on receiving such an indication, the lending component 108 can associate the amount of the credit offer with a credit balance of the payor 130.

In some examples, the graphical user interface 222 can include a slider, scale, or the like, which can enable the payor 130 to specify an amount of credit to use for payment and/or a limit of credit to use for payment. In some examples, as described above, different sources of funds can be used for repayment. In some examples, the payor 130 can specify that and in other examples, the payment optimization component 104 can determine combinations of payment intelligently. In some examples, a payment can be split and distributed by date, such that a first portion is paid on a first date and a second portion is paid on a second date after the first data, and so on. In some examples, timing associated with repayment can be specified by the payor 130 or determined by the payment optimization component 104 (e.g., intelligently).

FIG. 2E illustrates an example graphical user interface 228 that can present user interface elements 230 associated with final payment details. In at least one example, the payment details can include the amount of the payment, the payee, the record number, the due date, the arrival date, the form of payment, and/or the like. In at least one example, the graphical user interface 228 can include a user interface element 232, which can be associated with an actuation mechanism, to confirm payment details. In at least one example, based at least in part on a detected actuation of the actuation mechanism associated with the user interface element 232, the payor user interface 134 can send an indication of the confirmation to the server(s) 102. FIG. 2F illustrates an alternative example of the graphical user interface 228, wherein the user interface elements 230 include credit details (e.g., if the payor 130 opted to use credit/accept the credit offer for payment associated with the electronic record). As illustrated in FIG. 2F, the form of payment may not change (e.g., the payment is being made using the stored balance of the payor 130) but the backend management of how the funds are availed by the service provider may change (e.g., depending on whether the payor 130 accepted the credit offer).

Like FIGS. 2A-2C, the graphical user interfaces 222 and 228 can include the user interface element 202 to enable the payor 130 to navigate to another graphical user interface and/or access alternative data as described above. In at least one example, interaction with the user interface element 202 can cause a new graphical user interface to be presented and/or the graphical user interface from which the interaction was detected to be updated. In such an example, the resulting graphical user interface (e.g., new or updated) can present data associated with the payor 130.

FIG. 2G illustrates an example of a graphical user interface 234 that presents data associated with the payor 130. In at least one example, the graphical user interface 234 can include one or more user interface elements 236 that can indicate payments due, scheduled payments, paid payments, credit associated with the payor 130, and/or the like. In some examples, the payment optimization component 104 can analyze data associated with electronic records (e.g., context) to determine which unpaid electronic records are more relevant than others (e.g., due to be paid urgently, are overdue, merchant preference, etc.) and prioritize the presentation of such unpaid electronic records over other unpaid electronic records. In some examples, the payment optimization component 104 can aggregate electronic records associated with multiple payees and such an aggregation can be presented as a single line-item or electronic record in the graphical user interface 234. In some examples, individual of the user interface elements 236 can be associated with actuation mechanisms that enable the payor 130 to access additional or alternative information than what is presented via the graphical user interface 234. In some examples, by actuating an actuation mechanism associated with “scheduled” payments or “paid” payments, the payor user interface 134 can cause a new graphical user interface or an updated graphical user interface to be presented, which can include additional information with “scheduled” payments or “paid” payments. FIG. 2H illustrates an example graphical user interface 238 that includes user interface elements 240 representative of payments to be made. FIG. 2I illustrates an example graphical user interface 242 that includes user interface elements 244 representative of payments already made. In at least one example, the graphical user interfaces 238 and 240 can include a user interface element 246 that can enable the payor 130 to toggle between scheduled payments and paid payments (e.g., between the graphical user interface 238 and the graphical user interface 242).

In at least one example, the graphical user interfaces 234, 238, and 242 can include a user interface element 248 that can enable the payor 130 to add a record. In at least one example, actuation of an actuation mechanism associated with the user interface element 248 can cause the graphical user interface 200 to be presented via the payor user interface 134.

In at least one example, the graphical user interfaces described above with reference to FIGS. 2A-2I can be presented via a user-facing application, such as a buyer application, a peer-to-peer payment application, a payment application, and/or the like that can be associated with the service provider. For example, a peer-to-peer payment application can allow integration of electronic records, credit, stored balance, and/or the like and can enable a user to control each via the application. In some examples, payments can be represented in transaction history, which can represent other transactions of the user (e.g., brick-and-mortar, ecommerce, peer-to-peer payments, etc.).

FIG. 3 illustrates an example graphical user interface 300 that can be presented via the payee user interface 148, as described herein. In at least one example, a payee, such as the second payee 142, can utilize an invoicing service availed via the service provider described herein. In at least one example, the payee user interface 148 can present the graphical user interface 300 to enable the payee to generate a new invoice. In at least one example, the payee can input an amount to be paid, the payee, a record number, a due date, accepted forms of payment, preferred forms of payment, and/or the like. That is, the payee can input record data associated with the invoice via the payee user interface 148. Such record data is represented as user interface elements 302 associated with the graphical user interface 300. In some examples, some or all of the record data can be automatically populated based at least in part on previously input data, an estimate generated and/or sent prior to the invoice being generated, and/or the like.

In at least one example, the graphical user interface 300 can enable the payee to input identifiers or other addresses (e.g., email address, phone number, etc.) for sending the invoice to the payor 130 and/or service provider. In at least one example, the graphical user interface 300 can include a user interface element 304, which can be associated with an actuation mechanism, to enable the invoice to be sent to the payor 130 and/or the service provider. In at least one example, invoices—or bills and/or other electronic records—generated via the invoicing service of the service provider can be associated with the standardized format used for processing and/or storing electronic records as described above.

In at least one example, the graphical user interface 300 can be presented via a user-facing application, such as a merchant application, a point-of-sale application, a peer-to-peer payment application, a payment application, and/or the like that can be associated with the service provider. For example, a peer-to-peer payment application can allow integration of electronic records, credit, stored balance, and/or the like and can enable a user to control each via the application. In some examples, payments can be represented in transaction history, which can represent other transactions of the user (e.g., brick-and-mortar, ecommerce, peer-to-peer payments, etc.).

The graphical user interfaces described in FIGS. 2A-2I and 3 are non-limiting examples of graphical user interfaces that can be presented via the user interfaces, as described herein. Additional or alternative data and/or configurations of data can be presented via user interfaces as described herein. Further, in some examples, graphical user interfaces described may be presented in a different order and/or on or more of the graphical user interfaces may not be presented at all. In some examples, data can be presented via a speaker or other user interface.

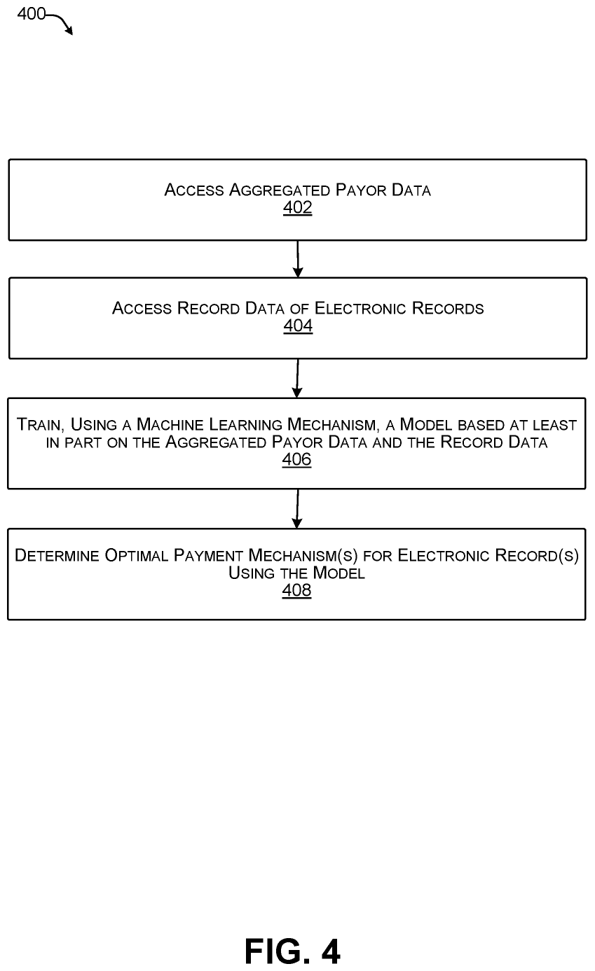

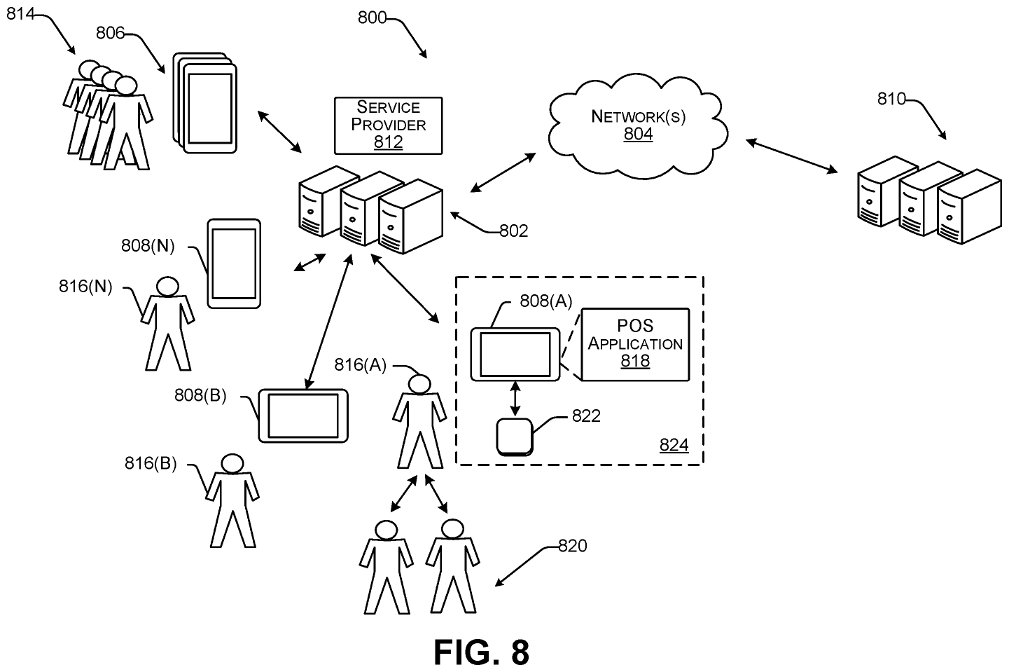

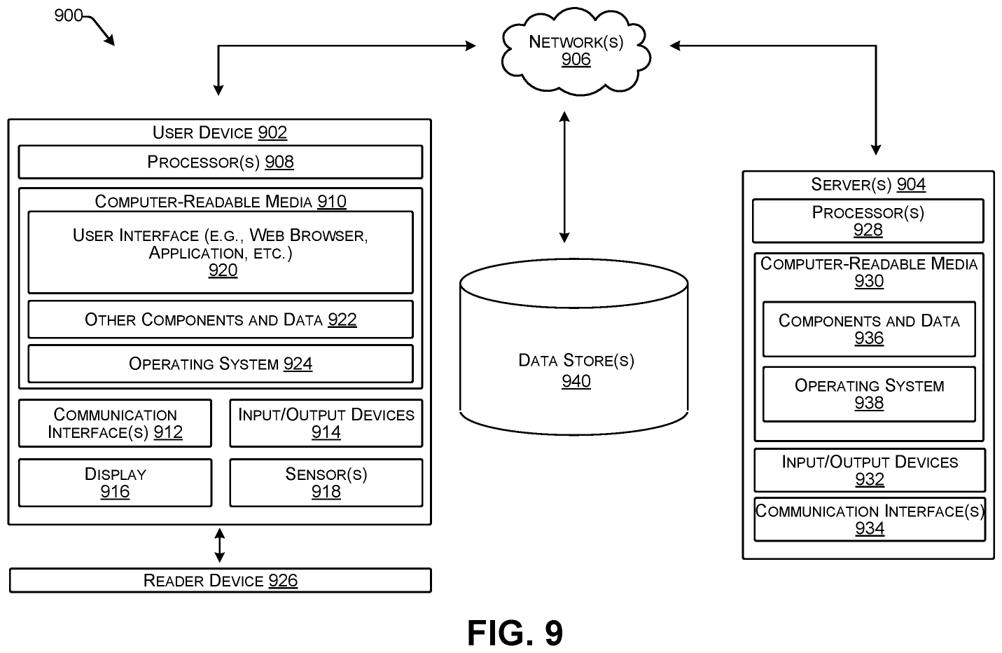

FIGS. 4-7 are flowcharts showing example processes involving techniques as described herein. The processes illustrated in FIGS. 4-7 are described with reference to FIG. 1 for convenience and ease of understanding. FIGS. 8 and 9 provide additional details associated with the components of FIG. 1 above. The processes illustrated in FIGS. 4-7 are not limited to being performed using components described in FIG. 1, and such components are not limited to performing the processes illustrated in FIGS. 4-7.

The processes 400-700 are illustrated as collections of blocks in logical flow graphs, which represent sequences of operations that can be implemented in hardware, software, or a combination thereof In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the processes 400-700 can be combined in whole or in part with each other or with other processes.

FIG. 4 illustrates an example process 400 for training a model, as described herein.

Block 402 illustrates accessing aggregated payor data. In at least one example, the training component 114 can access training data 128, which can include payor data 118 or a portion thereof. As described above, payor data 118 can comprise data associated with payor(s) that utilize services of the service provider for paying invoices, bills, and/or other electronic records requesting payment. In at least one example, the payor data 118 can include paid electronic records where associated payments are settled, outstanding electronic records where associated payments are not yet settled, past due electronic records where associated payments have not yet been settled and are past a due date for payment, and/or the like. In some examples, the payor data 118 can indicate forms of payment available to a payor (e.g., check, ACH or wire transfer (e.g., from a stored balance or other source of funds), credit card(s), debit card(s), linked bank account(s), cryptocurrency, peer-to-peer, real-time (non-peer-to-peer), loyalty reward(s), etc.), preferred forms of payment, previously used forms of payment, etc. In some examples, the payor data 118 can indicate a history of payments made by the payor, which can include indications of payees, dates payments were made, form(s) of payment used, timeliness of such payments (e.g., early, on time, late, etc.), fees assessed for particular payments, incentives/rewards earned for particular payments, etc. The payor data 118 can include information associated with payors, such as which service(s) of the service provider are used by a payor, data associated therewith, name of the payor, business information associated with the payor, linked bank account information associated with the payor, stored balance(s) associated with the payor, credit balance(s) associated with the payor, etc. In at least one example, the payor data 118 can be associated with a plurality of payors associated with the service provider and thus can be “aggregated payor data.”

Block 404 illustrates accessing record data of electronic records. In at least one example, the training component 114 can access training data 128, which can include record data 126 or a portion thereof. As described above, the record data 126 can comprise data associated with one or more electronic records. In at least one example, an electronic record can be associated with a payee, an amount to be paid by the payor, a due date for payment, acceptable form(s) of payment, a preferred form of payment, terms of payment (e.g., late fees, incentives for early payment, etc.), etc. In some examples, the record data 126 can indicate whether payment associated with an electronic record has been made and/or settled (e.g., a status associated therewith), the form of payment, the date of the payment, and/or the like. In some examples, the record data 126 can indicate statuses of the electronic records (e.g., paid, outstanding, late, etc.). The record data 126 can refer to aggregated record data of electronic records. In some examples, each electronic record can be associated with a portion of record data that is particular to the electronic record (e.g., a payee, an amount to be paid by the payor, a due date for payment, acceptable form(s) of payment, a preferred form of payment, terms of payment (e.g., late fees, incentives for early payment, etc.), etc.). In some examples, the payment optimization component 104 can receive electronic records of different formats and convert them into a standardized format for storing in the record data 126. Additional details are described below.

Block 406 illustrates training, using a machine learning mechanism, a model based at least in part on the aggregated payor data and the record data. In at least one example, the training component 114 can train one or more models using one or more machine-learning mechanisms. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, the machine-learning mechanism can analyze the aggregated payor data and/or the record data to generate machine-trained data models, which can output a recommendation with respect to a payment mechanism that optimizes payment for payors and/or payees. In some examples, such a recommendation can be referred to as an “optimal payment mechanism” and can indicate an optimal form of payment, date for payment, and/or time for payment. In at least one example, the machine-trained model(s) can be stored in the data store(s) 116 for use at a time after the machine-trained model(s) have been trained (e.g., at runtime).

In some examples, the model(s) can be trained on subsets of the payor data 118, payee data 120, and/or record data 126 such that individual of the model(s) can be particular to a subset of payors, payees, and/or transactions. For example, model(s) can be trained on data particular to similar payors, payees, and/or transactions. In some examples, model(s) can be trained on data particular to a single payor, payee, and/or transaction.

In at least one example, the electronic records and the text therein can be processed for topic categorization, sentiment analysis, machine translation, structured information extraction, and/or automatic summarization to determine context (urgency, payor, payee, etc.) that then helps determine how to prioritize the electronic records and generate payment mechanisms. For example, a machine learning classifier can be used on text associated with the electronic records to predict one or more categories or vectors, and in a subsequent step, decompose the prediction into the input domain, thus assigning to each word in the document a relevance score. Next, the model may filter out the words that do not meet a threshold, and visualize the rest, e.g., via cluster visualization. Accordingly, the model may make recommendations related to which electronic records to surface and which payment mechanisms to recommend for payment of each of the electronic records.

Block 408 illustrates determining optimal payment mechanism(s) for electronic record(s) using the model. In at least one example, and as described herein, the payment optimization component 104 can utilize the model to determine optimal payment mechanism(s) for electronic record(s). Additional details are provided below.

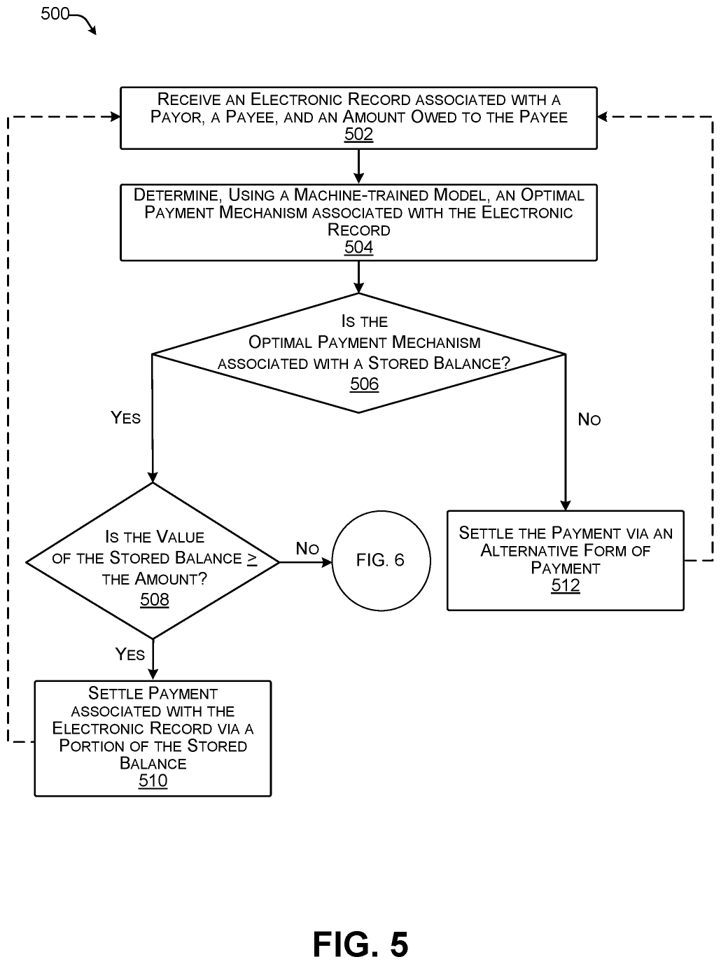

FIG. 5 illustrates an example process 500 for determining an optimal payment mechanism associated with a record and/or settling payment for such record, as described herein.

Block 502 illustrates receiving an electronic record associated with a payor, a payee, and an amount owed to the payee. In at least one example, the payment optimization component 104 can receive an electronic record, which can be associated with the payor 130, a payee, and at least an amount owed to the payee. In some examples, the electronic record can include an indication of when payment is due (e.g., a due date), acceptable form(s) of payment, preferred form(s) of payment, fee(s) for late payment, fee(s) for particular form(s) of payment, incentive(s) for early payment, incentive(s) for particular form(s) of payment, reward(s), and/or the like.

In some examples, the electronic record can be received from the payor computing device 132 (e.g., via the payor user interface 134). In such examples, the electronic record can be uploaded via the payor user interface 134, generated by the payor user interface 134 (e.g., based at least in part on record data manually entered by the payor 130), and/or forwarded from the payor computing device 132. In some examples, electronic records can be received from other components and/or other services of the service provider. That is, in some examples, another service of the service provider can send an electronic record to the payment optimization component 104. In some examples, electronic records can be received from third-party service providers.

In at least one example, the payment optimization component 104 can determine whether the electronic record is associated with a format different than the format in which record data 126 is stored by the service provider and/or can otherwise be processed. If the electronic record is associated with a non-standardized format, the payment optimization component 104 can convert the electronic record to a standardized format in which the record can be stored in the record data 126. That is, in an example where the payor 130 uploads an electronic record that is in a format different than the standardized format and/or forwards an electronic record that is in a format different than the standardized format, the payment optimization component 104 can convert the electronic record to the standardized format. In some examples, the payment optimization component 104 can process the electronic record using image recognition, natural language processing, and/or other models for extracting or otherwise determining record data associated with the electronic record. In some examples, the payment optimization component 104 can generate a new electronic record associated with the extracted record data and can store the new electronic record in the record data 126. In such examples, the new electronic record can be in a standardized format for storing in the record data 126 and/or processing by the payment optimization component 104.

In at least one example, the payment optimization component 104 can process the electronic record to determine record data associated therewith. That is, the payment optimization component 104 can use image recognition, natural language processing, and/or other models for extracting or otherwise determining record data associated with the electronic record.

Block 504 illustrates determining, using a machine-trained model, an optimal payment mechanism associated with the electronic record. In at least one example, the payment optimization component 104 can utilize the record data extracted from the electronic record to determine characteristics associated with the payor 130, the payee, and/or the transaction associated therewith. Such characteristic(s) can be used for intelligently determining one or more forms of payment, a date for payment, and/or a time for payment.

In at least one example, the payment optimization component 104 can access payor data 118 and/or other data stored in the data store(s) 116 to determine an optimal payment mechanism associated with the electronic record. In some examples, the payment optimization component 104 can utilize a machine-trained model, as described above with reference to FIG. 4, to determine such an optimal payment mechanism (e.g., a form of payment, a date, and/or a time for making a payment associated with the electronic record). In some examples, the payment optimization component 104 can additionally or alternatively utilize one or more rules to determine the optimal payment mechanism. In some examples, the optimal payment mechanism can be associated with a preferred form of payment of the payor 130, a preferred form of payment of the payee, a form of payment determined to provide a reward or other benefit to the payor 130, a form of payment determined to optimize cash flow of the payor 130, a form of payment determined to avoid a fee, and/or the like. In some examples, the optimal payment mechanism can be associated with a date and/or time that optimizes cash flow of the payor, provides an “instant” payment or timely payment for the payee, avoids a fee, provides a reward, and/or the like.

In some examples, the payment optimization component 104 can determine cash flow of the payor, based at least in part on payor data associated therewith, optional forms of payment for paying a payment associated with the electronic record, payee preference(s) for payment (e.g., which can include form(s) of payment, timing of payment (e.g., instant, etc.), etc.), fees associated with forms of payment and/or timelines of payment, rewards associated with forms of payment and/or timelines of payment, loyalty associated with forms of payment and/or timelines of payment, and/or the like. In some examples, the payment optimization component 104 can utilize such information to determine an optimal form of payment and/or a date and/or time for making such a payment. In some examples, the optimal payment mechanism can maximize cash flow, eliminate fees, provide rewards, and/or otherwise provide a benefit to the payor and/or payee.

In some examples, the payment optimization component 104 can utilize network-level information to determine the optimal payment mechanism. In such examples, benefits and/or risks to the service provider can be taken into consideration in determining the optimal form of payment and/or timeline. For example, the payment optimization component 104 can consider increases or reductions to fees paid by the service provider for bulk funds transfers, bulk payments, and/or the like.

Block 506 illustrates determining whether the optimal payment mechanism is associated with a stored balance (of the payor). In some examples, the optimal payment mechanism may be associated with a credit card payment or the like. In some examples, the optimal payment mechanism can be associated with a stored balance (e.g., an ACH transfer, a wire transfer, a check, or the like). In some examples, based at least in part on determining that the optimal payment mechanism is associated with the stored balance (e.g., funds associated with the stored balance are to be used for settling payment), the payment optimization component 104 can determine whether the value of the stored balance is greater than or equal to the amount of the payment.

Block 510 illustrates settling payment associated with the electronic record via a portion of the stored balance. In at least one example, if the value of the stored balance is great than or equal to the amount of the payment, the payment optimization component 104 can settle payment associated with the electronic record using a portion of the stored balance. In some examples, the payment optimization component 104 can transfer funds from the stored balance of the payor 130 to a stored balance of the payee. In some examples, the payment optimization component 104 can transfer funds from the stored balance of the payor 130 to a bank (account) of the payee. In some examples, the payment optimization component 104 can transfer funds from the stored balance of the payor 130 to another repository of the payee. In some examples, the payment optimization component 104 can withdraw the funds from the stored balance of the payor 130 (e.g., reduce the value of the stored balance of the payor 130), and settle payment via another form of payment (e.g., a check, a batch ACH transfer, credit, or the like). That is, in some examples, the source of funds can be the stored balance of the payor 130 and the service provider can select the form of payment (e.g., a credit card, an ACH or other electronic funds transfer, a check, cryptocurrency, a peer-to-peer payment, a real-time payment, etc.) used by the service provider for paying the payee. In some examples, the form (and/or timing) of payment can be based at least in part on the optimal payment mechanism recommended by the payment optimization component 104. In some examples, the payor 130 may be aware of the form (and/or timing) of payment used to settle the payment associated with the electronic record. In some examples, the payor 130 may not be aware of the form (and/or timing) of payment used to settle the payment associated with the electronic record.

In some examples, a portion of the payment can be settled using funds associated with the stored balance and the remaining portion can be settled via an alternative payment mechanism as described herein. For example, the payor 130 can utilize credit offered by the service provider for payment of the remaining portion. In some examples, the payment optimization component 104 can settle the full payment via a single form (even though the payor uses two different sources of funds to pay the service provider) or multiple forms of payment. In another example, the payor 130 can utilize credit associated with a third-party service provider, a linked bank account, and/or the like to settle the remaining portion of the payment.

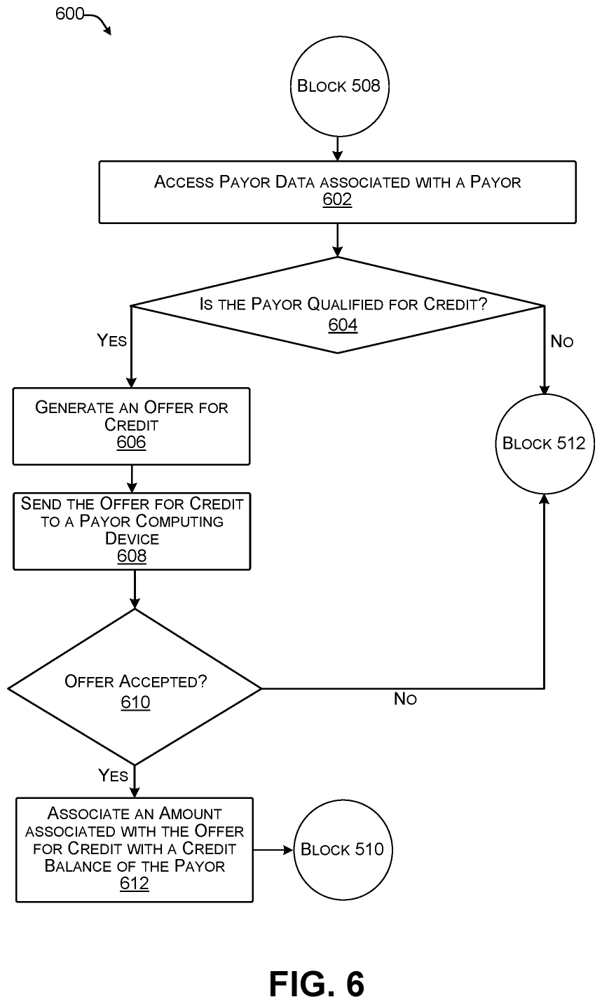

In at least one example, if the value of the stored balance is less than the amount of the payment, the process 500 can continue to FIG. 6, wherein the lending component 108 can offer the payor 130 credit to use for settling the payment.

Block 512 illustrates settling the payment via an alternative form of payment. In at least one example, if the optimal payment mechanism is associated with another form that does not involve the stored balance, the payment optimization component 104 can settle the payment using the recommended (optimal) form of payment. In some examples, two or more forms of payment can be used to settle a payment. In some examples, a form of payment used to settle the payment can be different than the source of funds for the payment. For example, a form of payment can be a preferred form of payment of the payee and the source of funds can be from a cryptocurrency balance of the payor, a peer-to-peer payment balance of the payor, etc.

As shown by the dashed lines returning to block 502, the process 500 can be repeated for each electronic record received by the service provider. In some examples, each electronic record can be processed and/or settled via the same form of payment. In some examples, individual electronic records can be processed and/or settled via different forms of payment. In some examples, a single electronic record can be processed and/or settled via a combination of different forms of payment/sources of funds. As described herein, the payment optimization component 104 can utilize rules and/or machine-trained models that take into account transaction characteristics, payor characteristics of the payor, and/or payee characteristics (e.g., of the payee) to determine (i) whether to use traditional payment rails (or utilize funds availed via the service provider) and/or (ii) which payment rails to use for individual transactions. In such examples, techniques described herein can determine whether to use such payment rails and/or which payment rails to use in a “dynamic” fashion, on a per transaction or per electronic record basis. In some examples, the payment optimization component 104 can extract relevant electronic records based at least in part on priority (e.g., due dates, past due, payor preference, etc.) prior to determining optimal payment mechanisms associated therewith.

FIG. 6 illustrates an example process 600 for generating a credit offer for a payor and/or settling payment for a record based at least in part on the credit offer, as described herein.

Block 602 illustrates accessing payor data associated with a payor. In at least one example, the lending component 108 can access payor data 118 associated with the payor 130. As described above, payor data 118 can comprise data associated with payor(s) that utilize services of the service provider for paying invoices, bills, and/or other electronic records requesting payment. In at least one example, the payor data 118 can include paid electronic records where associated payments are settled, outstanding electronic records where associated payments are not yet settled, past due electronic records where associated payments have not yet been settled and are past a due date for payment, and/or the like. In some examples, the payor data 118 can indicate forms of payment available to a payor (e.g., check, ACH or wire transfer (e.g., from a stored balance or other source of funds), credit card(s), debit card(s), linked bank account(s), cryptocurrency, peer-to-peer, real-time (non-peer-to-peer), loyalty reward(s), etc.), preferred forms of payment, previously used forms of payment, etc. In some examples, the payor data 118 can indicate a history of payments made by the payor, which can include indications of payees, dates payments were made, form(s) of payment used, timeliness of such payments (e.g., early, on time, late, etc.), fees assessed for particular payments, incentives/rewards earned for particular payments, etc. The payor data 118 can include information associated with payors, such as which service(s) of the service provider are used by a payor, name of the payor, business information associated with the payor, linked bank account information associated with the payor, stored balance(s) associated with the payor, credit balance(s) associated with the payor, credit signals associated with the payor, fraud signals associated with the payor, linked third-party data (e.g., FICO scores, etc.), etc.

Block 604 illustrates determining whether the payor is qualified for credit. In at least one example, the lending component 108 can analyze the payor data 118 and/or any other data associated with the payor 130 to determine whether the payor 130 is qualified for credit. In at least one example, the lending component 108 can utilize machine-trained model(s) and/or rules for determining a credit score and/or level of risk associated with the payor 130. In some examples, such determinations can be in real-time or pre-determined. As described above, such decisions can be made based on based on signals about the payor (e.g., based on payor data and/or other indications of creditworthiness and/or risk), signals about the payee, data associated with electronic record(s), and/or the like. In some examples, such data and/or signals can be associated with the service provider (e.g., stored in the data store(s) 116) and/or received via APIs associated with third-party sources. If the credit score and/or level of risk determined for the payor 130 satisfies a threshold, the lending component 108 can determine that the payor 130 is qualified for credit. For example, if the credit score meets or exceeds a threshold, the payor 130 can qualify for credit and/or if the level of risk is below a threshold, the payor 130 can qualify for credit.

Block 606 illustrates generating an offer for credit. In at least one example, the lending component 108 can generate credit offers. In some examples, terms of such credit offers can be determined based at least in part on the payor data and/or other data indicative of creditworthiness or risk of the payor 130. That is, the lending component 108 can determine a credit signal and/or risk signal associated with a payor (or other offeree) and can determine terms of a credit offer based at least in part on the credit signal and/or risk signal. Such terms can include time for repayment, acceptable forms of repayment, fees associated with the credit offer, late fees associated with late repayment, and/or the like.

Block 608 illustrates sending the offer for credit to a payor computing device. In at least one example, the lending component 108 can send the credit offer to the payor 130 (e.g., to the payor computing device 132). In at least one example, the credit offer can be presented via the payor user interface 134. In some examples, the credit offer can be sent as a text message, email, push notification, in-application notification, and/or the like.

Block 610 illustrates determining whether the offer is accepted. The lending component 108 can determine whether the offer is accepted based at least in part on communications received from the payor computing device 132. In at least one example, the payor user interface 134 can detect an interaction indicating that the payor 130 accepts the offer for credit. In some examples, the offer for credit, when presented, can include an actuation mechanism to enable the payor 130 to accept the offer. In some examples, another interaction can indicate the payor's 130 acceptance and agreement to the terms of the credit offer. The payor user interface 134 can send an indication of such to the lending component 108. In some examples, the payor 130 can accept part of the offer and, in some examples, can defer use of the remaining part for payment of another electronic record. That said, if the offer is tied to a particular transaction, the payor 130 may not be permitted to defer use of the remaining part for payment of another record.

Block 612 illustrates associating an amount associated with the offer for credit with a credit balance of the payor. In at least one example, based at least in part on the lending component 108 receiving an indication that the payor 130 accepts the credit offer, the lending component 108 can send an indication of such to the balance management component 110. The balance management component 110 can determine whether the payor 130 is associated with an existing credit balance and, if the payor 130 is associated with an existing credit balance (e.g., of the credit balance(s) 124), the balance management component 110 can add the amount of credit associated with the credit offer to the credit balance of the payor 130. If the payor 130 is not associated with a credit balance, the balance management component 110 can generate a new credit balance for the payor 130. In either example, the amount of the credit associated with the credit offer can be associated with a credit balance associated with the payor 130.

A credit balance, as described above, can be managed by the service provider. In at least one example, the credit balance can comprise any funds loaned to the payor by the service provider. That is, in some examples, the credit balance can comprise credit extended via one or more products and/or offers associated therewith. In at least one example, the lending component 108 can manage repayment of the credit balance. The credit balance can be repaid using proceeds of payment(s) processed by the service provider on behalf of the payor, peer-to-peer payment(s) received by the service provider on behalf of the payor, receivables from invoice(s) invoiced by the service provider on behalf of the payor, payments made by the payor (e.g., from a linked bank account, etc.), and/or the like. In some examples, the payor can have a grace period for repayment of the credit balance. In some examples, the grace period or other timeline for repayment of the credit balance can be agnostic to the due date of payments settled using credit associated with the credit balance. That is, in some examples, using credit, as described herein, can extend the timeline for payors to make payments. For instance, if a payee does not accept credit cards, paying using credit extended by the service provider can provide a payor longer to make a payment than what the payor would have been able to without credit options as described herein.

In an example where the payor 130 is not qualified for credit, the process 600 can return to block 512 of FIG. 5 and the payment optimization component 104 can determine an alternative form of payment for settling the payment associated with the electronic record. Similarly, if the payor 130 does not accept the offer for credit, the process 600 can return to block 512 of FIG. 5 and the payment optimization component 104 can determine an alternative form of payment for settling the payment associated with the electronic record.

In at least one example, based at least in part on the payor 130 accepting the offer, the process 600 can return to block 510 of FIG. 5 and can settle the payment using at least a portion of the stored balance.

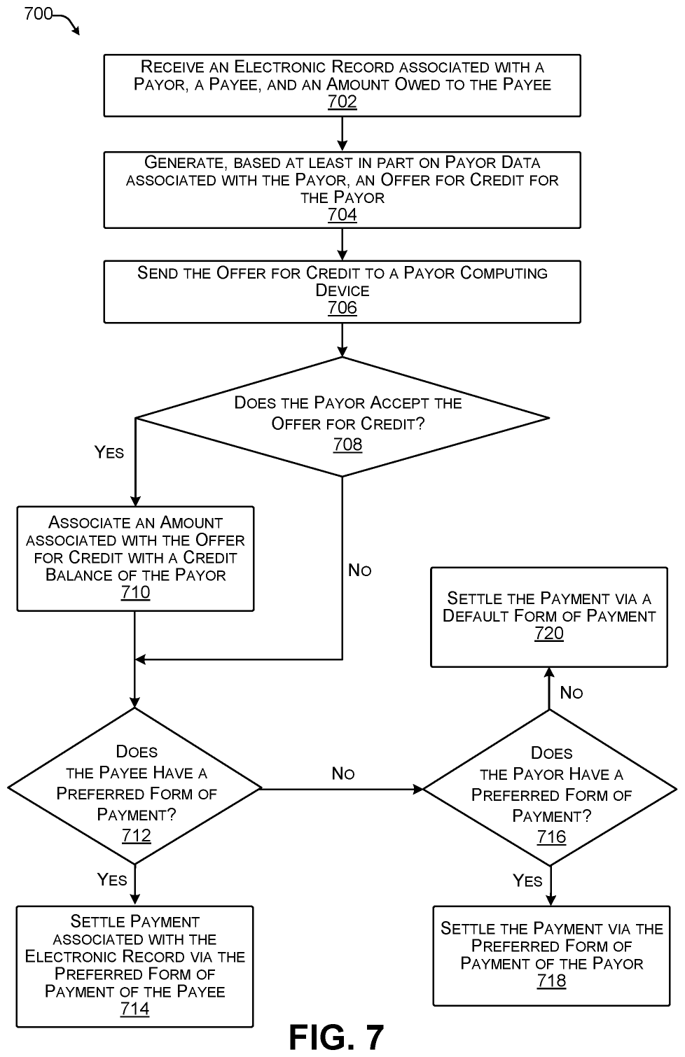

FIG. 7 illustrates another example process 700 for generating a credit offer for a payor and/or settling payment for a record based at least in part on the credit offer, as described herein.

Block 702 illustrates receiving an electronic record associated with a payor, a payee, and an amount owed to the payee, as described above with reference to block 502 of FIG. 5.

Block 704 illustrates generating, based at least in part on payor data associated with the payor, an offer for credit for the payor, as described above with reference to block 606 of FIG. 6.

Block 706 illustrates sending the offer for credit to a payor computing device, as described above with reference to block 608 of FIG. 6.

Block 708 illustrates determining whether the payor accepts the offer for credit, as described above with reference to block 610 of FIG. 6.

Block 710 illustrates associating an amount associated with the offer for credit with a credit balance of the payor, as described above with reference to block 612 of FIG. 6.

Block 712 illustrates determining whether the payee has a preferred form of payment. In at least one example, the payee can be associated with a preferred form of payment. In some examples, such a preference can be stored in the payee data 120. In some examples, such a preference can be indicated in record data associated with the electronic record. In some examples, such a preference can be learned (e.g., based on preferences of payees determined to be similar to the payee). In at least one example, based at least in part on determining a preferred form of payment of the payee, the payment optimization component 104 can settle payment associated with the electronic record via the preferred form of payment of the payee, as illustrated in block 714. In some examples, the preferred form of payment of the payee can be an ACH transfer, a wire transfer, a check, credit, or the like. The payment optimization component 104 can settle the payment via the preferred form of payment of the payee. In some examples, the payment optimization component 104 can settle the payment via a preferred time (e.g., instant, within a threshold period of time, timely, etc.) of the payee. In some examples, at least a portion of the funds provided by the payor 130 to the service provider can be via the credit offer accepted (and loan subsequently issued). In some examples, at least a portion of the funds provided by the payor 130 to the service provider can be via the stored balance of the payor 130. Additional or alternative sources of funds can be used by the payor 130 to pay the service provider.

In an example where the payee is not associated with a preferred form of payment, the payment optimization component 104 can determine whether the payor 130 has a preferred form of payment, as illustrated in block 716. In at least one example, the payor 130 can be associated with a preferred form of payment. In some examples, such a preference can be stored in the payor data 118. In some examples, such a preference can be learned (e.g., based on preferences of payors determined to be similar to the payor 130). In at least one example, based at least in part on determining a preferred form of payment of the payor 130, the payment optimization component 104 can settle payment associated with the electronic record via the preferred form of payment of the payor 130, as illustrated in block 718. In some examples, the preferred form of payment of the payor 130 can be an ACH transfer, a wire transfer, a check, credit, or the like. The payment optimization component 104 can settle the payment via the preferred form of payment of the payor 130. The funds provided by the payor 130 to the service provider can be via the credit offer accepted (and loan subsequently issued). As such, in some examples, by accepting the credit offer, the lending component 112 can increase the value of the stored balance of the payor 130 which can be used by the payment optimization component 104 to settle the payment. Additional or alternative sources of funds can be used by the payor 130 to pay the service provider.

In some examples, if neither the payee nor the payor 130 have a preferred form of payment, the payment optimization component 104 can settle the payment via a default form of payment, as illustrated in block 720. In some examples, the default form of payment can be the optimal form of payment as determined by the payment optimization component 104. In some examples, one or more rules can determine whether the payee preference is prioritized over the payor preference and/or a default form of payment. In some examples, the payment optimization component 104 can determine whether the payor 130 is associated with a preference and settle the payment via the payor 130 preference prior to considering the payee preference.

FIG. 8 illustrates an example environment 800. The environment 800 includes server computing device(s) 802 that can communicate over one or more networks 804 with user devices 806 (which, in some examples can be merchant devices 808 (individually, 808(A)-808(N))) and/or server computing device(s) 810 associated with third-party service provider(s). The server computing device(s) 802 can be associated with a service provider 812 that can provide one or more services for the benefit of users 814, as described below. Actions attributed to the service provider 812 can be performed by the server computing device(s) 802.

In at least one example, the server(s) 102 of FIG. 1 can correspond to the server computing devices(s) 802 of FIG. 8, the payor 130 and/or the payees 138, 142 can comprise at least some of the users 814, the payor computing device 132 and/or the payee computing device 146 can comprise at least some of the user computing devices 806, and the network(s) 136 can correspond to the network(s) 804.

The environment 800 can include user devices 806, as described above. Each one of the plurality of user devices 806 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices can be operable by users 814. The users 814 can be referred to as customers, buyers, merchants, sellers, borrowers, employees, employers, payors, payees, couriers and so on. The users 814 can interact with the user devices 806 via user interfaces presented via the user devices 806. In at least one example, a user interface can be presented via a web browser, or the like. In other examples, a user interface can be presented via an application, such as a mobile application or desktop application, which can be provided by the service provider 812 or which can be an otherwise dedicated application. In some examples, individual of the user devices 806 can have an instance or versioned instance of an application, which can be downloaded from an application store, for example, which can present the user interface(s) described herein. In at least one example, a user 814 can interact with the user interface via touch input, spoken input, or any other type of input.

As described above, in at least one example, the users 814 can include merchants 816 (individually, 816(A)-816(N)). In at least one example, individual of the merchants 816 can also be payors and/or payees as described above with reference to FIGS. 1-7. In at least one example, the merchants 816 can operate respective merchant devices 808, which can be user devices 806 configured for use by merchants 816. For the purpose of this discussion, a “merchant” can be any entity that offers items (e.g., goods or services) for purchase or other means of acquisition (e.g., rent, borrow, barter, etc.). The merchants 816 can offer items for purchase or other means of acquisition via brick-and-mortar stores, mobile stores (e.g., pop-up shops, food trucks, etc.), online stores, combinations of the foregoing, and so forth. In some examples, at least some of the merchants 816 can be associated with a same entity but can have different merchant locations and/or can have franchise/franchisee relationships. In additional or alternative examples, the merchants 816 can be different merchants. That is, in at least one example, the merchant 816(A) is a different merchant than the merchant 816(B) and/or the merchant 816(C).

For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

Each merchant device 808 can have an instance of a POS application 818 stored thereon. The POS application 818 can configure the merchant device 808 as a POS terminal, which enables the merchant 816(A) to interact with one or more customers 820. As described above, the users 814 can include customers, such as the customers 820 shown as interacting with the merchant 816(A). For the purpose of this discussion, a “customer” can be any entity that acquires items from merchants. While only two customers 820 are illustrated in FIG. 8, any number of customers 820 can interact with the merchants 816. Further, while FIG. 8 illustrates the customers 820 interacting with the merchant 816(A), the customers 820 can interact with any of the merchants 816.

In at least one example, interactions between the customers 820 and the merchants 816 that involve the exchange of funds (from the customers 820) for items (from the merchants 816) can be referred to as “POS transactions” and/or “transactions.” In at least one example, the POS application 818 can determine transaction data associated with the POS transactions. Transaction data can include payment information, which can be obtained from a reader device 822 associated with the merchant device 808(A), user authentication data, purchase amount information, point-of-purchase information (e.g., item(s) purchased, date of purchase, time of purchase, etc.), etc. The POS application 818 can send transaction data to the server computing device(s) 802. Furthermore, the POS application 818 can present a UI to enable the merchant 816(A) to interact with the POS application 818 and/or the service provider 812 via the POS application 818.

In at least one example, the merchant device 808(A) can be a special-purpose computing device configured as a POS terminal (via the execution of the POS application 818). In at least one example, the POS terminal may be connected to a reader device 822, which is capable of accepting a variety of payment instruments, such as credit cards, debit cards, gift cards, short-range communication based payment instruments, and the like, as described below. In at least one example, the reader device 822 can plug in to a port in the merchant device 808(A), such as a microphone port, a headphone port, an audio-jack, a data port, or other suitable port. In additional or alternative examples, the reader device 822 can be coupled to the merchant device 808(A) via another wired or wireless connection, such as via a Bluetooth®, BLE, and so on. Additional details are described below with reference to FIG. 9. In some examples, the reader device 822 can read information from alternative payment instruments including, but not limited to, wristbands and the like.

In some examples, the reader device 822 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards or devices configured for tapping). The POS terminal may provide a rich user interface, communicate with the reader device 822, and communicate with the server computing device(s) 802, which can provide, among other services, a payment processing service. The server computing device(s) 802 associated with the service provider 812 can communicate with server computing device(s) 810, as described below. In this manner, the POS terminal and reader device 822 may collectively process transaction(s) between the merchants 816 and customers 820. In some examples, POS terminals and reader devices can be configured in one-to-one pairings. In other examples, the POS terminals and reader devices can be configured in many-to-one pairings (e.g., one POS terminal coupled to multiple reader devices or multiple POS terminals coupled to one reader device). In some examples, there could be multiple POS terminal(s) connected to a number of other devices, such as “secondary” terminals, e.g., back-of-the-house systems, printers, line-buster devices, POS readers, and the like, to allow for information from the secondary terminal to be shared between the primary POS terminal(s) and secondary terminal(s), for example via short-range communication technology. This kind of arrangement may also work in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While, the POS terminal and the reader device 822 of the POS system 824 are shown as separate devices, in additional or alternative examples, the POS terminal and the reader device 822 can be part of a single device. In some examples, the reader device 822 can have a display integrated therein for presenting information to the customers 820. In additional or alternative examples, the POS terminal can have a display integrated therein for presenting information to the customers 820. POS systems, such as the POS system 824, may be mobile, such that POS terminals and reader devices may process transactions in disparate locations across the world. POS systems can be used for processing card-present transactions and card-not-present (CNP) transactions, as described below.

A card-present transaction is a transaction where both a customer 820 and his or her payment instrument are physically present at the time of the transaction. Card-present transactions may be processed by swipes, dips, taps, or any other interaction between a physical payment instrument (e.g., a card), or otherwise present payment instrument, and a reader device 822 whereby the reader device 822 is able to obtain payment data from the payment instrument. A swipe is a card-present transaction where a customer 820 slides a card, or other payment instrument, having a magnetic strip through a reader device 822 that captures payment data contained in the magnetic strip. A dip is a card-present transaction where a customer 820 inserts a payment instrument having an embedded microchip (i.e., chip) into a reader device 822 first. The dipped payment instrument remains in the payment reader until the reader device 822 prompts the customer 820 to remove the card, or other payment instrument. While the payment instrument is in the reader device 822, the microchip can create a one-time code which is sent from the POS system 824 to the server computing device(s) 810 (which can be associated with third-party service providers that provide payment services, including but not limited to, an acquirer bank, an issuer, and/or a card payment network (e.g., Mastercard®, VISA®, etc.)) to be matched with an identical one-time code. A tap is a card-present transaction where a customer 820 may tap or hover his or her payment instrument (e.g., card, electronic device such as a smart phone running a payment application, etc.) over a reader device 822 to complete a transaction via short-range communication (e.g., NFC, RFID, Bluetooth®, BLE, etc.). Short-range communication enables the payment instrument to exchange information with the reader device 822. A tap may also be called a contactless payment.

A CNP transaction is a transaction where a card, or other payment instrument, is not physically present at the POS such that payment data is required to be manually keyed in (e.g., by a merchant, customer, etc.), or payment data is required to be recalled from a card-on-file data store, to complete the transaction.

The POS system 824, the server computing device(s) 802, and/or the server computing device(s) 810 may exchange payment information and transaction data to determine whether transactions are authorized. For example, the POS system 824 may provide encrypted payment data, user authentication data, purchase amount information, point-of-purchase information, etc. (collectively, transaction data) to server computing device(s) 802 over the network(s) 804. The server computing device(s) 802 may send the transaction data to the server computing device(s) 810. As described above, in at least one example, the server computing device(s) 810 can be associated with third-party service providers that provide payment services, including but not limited to, an acquirer bank, an issuer, and/or a card payment network (e.g., Mastercard®, VISA®, etc.)

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. The acquirer (e.g., the server computing device(s) 810 associated therewith) can send a fund transfer request to a server computing device of a card payment network (e.g., Mastercard®, VISA®, etc.) to determine whether the transaction is authorized or deficient. In at least one example, the service provider 812 can serve as an acquirer and connect directly with the card payment network.

The card payment network (e.g., the server computing device(s) 810 associated therewith) can forward the fund transfer request to an issuing bank (e.g., “issuer”). The issuer is a bank or financial institution that offers a financial account (e.g., credit or debit card account) to a user. An issuer can issue payment cards to users and can pay acquirers for purchases made by cardholders to which the issuing bank has issued a payment card. The issuer (e.g., the server computing device(s) 810 associated therewith) can make a determination as to whether the customer has the capacity to absorb the relevant charge associated with the payment transaction. In at least one example, the service provider 812 can serve as an issuer and/or can partner with an issuer. The transaction is either approved or rejected by the issuer and/or the card payment network (e.g., the server computing device(s) 810 associated therewith), and a payment authorization message is communicated from the issuer to the POS device via a path opposite of that described above, or via an alternate path.

As described above, the server computing device(s) 810, which can be associated with payment service provider(s), may determine whether the transaction is authorized based on the transaction data, as well as information relating to parties to the transaction (e.g., the customer 820 and/or the merchant 816(A)). The server computing device(s) 810 may send an authorization notification over the network(s) 804 to the server computing device(s) 802, which may send the authorization notification to the POS system 824 over the network(s) 804 to indicate whether the transaction is authorized. The server computing device(s) 802 may also transmit additional information such as transaction identifiers to the POS system 824. In one example, the server computing device(s) 802 may include a merchant application and/or other functional components for communicating with the POS system 824 and/or the server computing device(s) 810 to authorize or decline transactions.

Based on the authentication notification that is received by the POS system 824 from server computing device(s) 802, the merchant 816(A) may indicate to the customer 820 whether the transaction has been approved. In some examples, approval may be indicated at the POS system 824, for example, at a display of the POS system 824. In other examples, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

As mentioned above, the service provider 812 can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, peer-to-peer payment services, onboarding services, identity verification (IDV) services, and so on. In some examples, the users 814 can access all of the services of the service provider 812. In other examples, the users 814 can have gradated access to the services, which can be based on risk tolerance, IDV outputs, subscriptions, and so on. In at least one example, access to such services can be availed to the merchants 816 via the POS application 818. In additional or alternative examples, each service can be associated with its own access point (e.g., application, web browser, etc.).

The service provider 812 can offer payment processing services for processing payments on behalf of the merchants 816, as described above. For example, the service provider 812 can provision payment processing software, payment processing hardware and/or payment processing services to merchants 816, as described above, to enable the merchants 816 to receive payments from the customers 820 when conducting POS transactions with the customers 820. For instance, the service provider 812 can enable the merchants 816 to receive cash payments, payment card payments, and/or electronic payments from customers 820 for POS transactions and the service provider 812 can process transactions on behalf of the merchants 816.

As the service provider 812 processes transactions on behalf of the merchants 816, the service provider 812 can maintain accounts or balances for the merchants 816 in one or more ledgers. For example, the service provider 812 can analyze transaction data received for a transaction to determine an amount of funds owed to a merchant 816(A) for the transaction. In at least one example, such an amount can be a total purchase price less fees charged by the service provider 812 for providing the payment processing services. Based on determining the amount of funds owed to the merchant 816(A), the service provider 812 can deposit funds into an account of the merchant 816(A). The account can have a stored balance, which can be managed by the service provider 812. The account can be different from a conventional bank account at least because the stored balance is managed by a ledger of the service provider 812 and the associated funds are accessible via various withdrawal channels including, but not limited to, scheduled deposit, same-day deposit, instant deposit, and a linked payment instrument.

A scheduled deposit can occur when the service provider 812 transfers funds associated with a stored balance of the merchant 816(A) to a bank account of the merchant 816(A) that is held at a bank or other financial institution (e.g., associated with the server computing device(s) 810). Scheduled deposits can occur at a prearranged time after a POS transaction is funded, which can be a business day after the POS transaction occurred, or sooner or later. In some examples, the merchant 816(A) can access funds prior to a scheduled deposit. For instance, the merchant 816(A) may have access to same-day deposits (e.g., wherein the service provider 812 deposits funds from the stored balance to a linked bank account of the merchant on a same day as POS transaction, in some examples prior to the POS transaction being funded) or instant deposits (e.g., wherein the service provider 812 deposits funds from the stored balance to a linked bank account of the merchant on demand, such as responsive to a request). Further, in at least one example, the merchant 816(A) can have a payment instrument that is linked to the stored balance that enables the merchant to access the funds without first transferring the funds from the account managed by the service provider 812 to the bank account of the merchant 816(A).

In at least one example, the service provider 812 may provide inventory management services. That is, the service provider 812 may provide inventory tracking and reporting. Inventory management services may enable the merchant 816(A) to access and manage a database storing data associated with a quantity of each item that the merchant 816(A) has available (i.e., an inventory). Furthermore, in at least one example, the service provider 812 can provide catalog management services to enable the merchant 816(A) to maintain a catalog, which can be a database storing data associated with items that the merchant 816(A) has available for acquisition (i.e., catalog management services). In at least one example, the catalog may include a plurality of data items and a data item of the plurality of data items may represent an item that the merchant 8121(A) has available for acquisition. The service provider 812 can offer recommendations related to pricing of the items, placement of items on the catalog, and multi-party fulfillment of the inventory.

In at least one example, the service provider 812 can provide business banking services, which allow the merchant 816(A) to track deposits (from payment processing and/or other sources of funds) into an account of the merchant 816(A), payroll payments from the account (e.g., payments to employees of the merchant 816(A)), payments to other merchants (e.g., business-to-business) directly from the account or from a linked debit card, withdrawals made via scheduled deposit and/or instant deposit, etc. Furthermore, the business banking services can enable the merchant 816(A) to obtain a customized payment instrument (e.g., credit card), check how much money they are earning (e.g., via presentation of available earned balance), understand where their money is going (e.g., via deposit reports (which can include a breakdown of fees), spend reports, etc.), access/use earned money (e.g., via scheduled deposit, instant deposit, linked payment instrument, etc.), feel in control of their money (e.g., via management of deposit schedule, deposit speed, linked instruments, etc.), etc. Moreover, the business banking services can enable the merchants 816 to visualize their cash flow to track their financial health, set aside money for upcoming obligations (e.g., savings), organize money around goals, etc.

In at least one example, the service provider 812 can provide financing services and products, such as via business loans, consumer loans, fixed term loans, flexible term loans, and the like. In at least one example, the service provider 812 can utilize one or more risk signals to determine whether to extend financing offers and/or terms associated with such financing offers.

In at least one example, the service provider 812 can provide financing services for offering and/or lending a loan to a borrower that is to be used for, in some instances, financing the borrower's short-term operational needs (e.g., a capital loan). For instance, a potential borrower that is a merchant can obtain a capital loan via a capital loan product in order to finance various operational costs (e.g., rent, payroll, inventory, etc.). In at least one example, the service provider 812 can offer different types of capital loan products. For instance, in at least one example, the service provider 812 can offer a daily repayment loan product, wherein a capital loan is repaid daily, for instance, from a portion of transactions processed by the payment processing service on behalf of the borrower. Additionally and/or alternatively, the service provider 812 can offer a monthly repayment loan product, wherein a capital loan is repaid monthly, for instance, via a debit from a bank account linked to the payment processing service. The credit risk of the merchant may be evaluated using risk models that take into account factors, such as payment volume, credit risk of similarly situated merchants, past transaction history, seasonality, credit history, and so on.

Additionally or alternatively, the service provider 812 can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant, which can be one of the merchants 816. The service provider 812 can generate the loan based at least in part on determining that the borrower purchased or intends to purchase the item from the merchant. The loan can be associated with a balance based on an actual purchase price of the item and the borrower can repay the loan over time. In some examples, the borrower can repay the loan via installments, which can be paid via funds managed and/or maintained by the service provider 812 (e.g., from payments owed to the merchant from payments processed on behalf of the merchant, funds transferred to the merchant, etc.). The service provider 812 can offer specific financial products, such as payment instruments, tied specifically to the loan products. For example, in one implementation, the server provider 812 associates capital to a merchant or customer's debit card, where the use of the debit card is defined by the terms of the loan. In some examples, the merchant may only use the debit card for making specific purchases. In other examples, the “installment” associated with the loan product is credited directly via the payment instrument. The payment instrument is thus customized to the loan and/or the parties associated with the loan.

The service provider 812 can provide web-development services, which enable users 814 who are unfamiliar with HTML, XML, Javascript, CSS, or other web design tools to create and maintain professional and aesthetically pleasing websites. Some of these web page editing applications allow users to build a web page and/or modify a web page (e.g., change, add, or remove content associated with a web page). Further, in addition to websites, the web-development services can create and maintain other online omni-channel presences, such as social media posts for example. In some examples, the resulting web page(s) and/or other content items can be used for offering item(s) for sale via an online/e-commerce platform. That is, the resulting web page(s) and/or other content items can be associated with an online store or offering by the one or more of the merchants 816. In at least one example, the service provider 812 can recommend and/or generate content items to supplement omni-channel presences of the merchants 816. That is, if a merchant of the merchants 816 has a web page, the service provider 812—via the web-development or other services—can recommend and/or generate additional content items to be presented via other channel(s), such as social media, email, etc.

Furthermore, the service provider 812 can provide payroll services to enable employers to pay employees for work performed on behalf of employers. In at least one example, the service provider 812 can receive data that includes time worked by an employee (e.g., through imported timecards and/or POS interactions), sales made by the employee, gratuities received by the employee, and so forth. Based on such data, the service provider 812 can make payroll payments to employee(s) on behalf of an employer via the payroll service. For instance, the service provider 812 can facilitate the transfer of a total amount to be paid out for the payroll of an employee from the bank of the employer to the bank of the service provider 812 to be used to make payroll payments. In at least one example, when the funds have been received at the bank of the service provider 812, the service provider 812 can pay the employee, such as by check or direct deposit, often a day, a week, or more after when the work was actually performed by the employee. In additional or alternative examples, the service provider 812 can enable employee(s) to receive payments via same-day or instant deposit based at least in part on risk and/or reliability analyses performed by the service provider 812.

Moreover, in at least one example, the service provider 812 can provide employee management services for managing schedules of employees. Further, the service provider 812 can provide appointment services for enabling users 814 to set schedules for scheduling appointments and/or users 814 to schedule appointments.

In some examples, the service provider 812 can provide restaurant management services to enable users 814 to make and/or manage reservations, to monitor front-of-house and/or back-of-house operations, and so on. In such examples, the merchant device(s) 808 and/or server computing device(s) 802 can be configured to communicate with one or more other computing devices, which can be located in the front-of-house (e.g., POS device(s)) and/or back-of-house (e.g., kitchen display system(s) (KDS)). In at least one example, the service provider 812 can provide order management services and/or fulfillment services to enable restaurants to manage open tickets, split tickets, and so on and/or manage fulfillment services. In some examples, such services can be associated with restaurant merchants, as described above. In additional or alternative examples, such services can be any type of merchant.

In at least one example, the service provider 812 can provide fulfillment services, which can use couriers for delivery, wherein couriers can travel between multiple locations to provide delivery services, photography services, etc. Couriers can be users 814 who can travel between locations to perform services for a requesting user 814 (e.g., deliver items, capture images, etc.). In some examples, the courier can receive compensation from the service provider 812. The courier can employ one or more vehicles, such as automobiles, bicycles, scooters, motorcycles, buses, airplanes, helicopters, boats, skateboards, etc. Although, in other instances the courier can travel by foot or otherwise without a vehicle. Some examples discussed herein enable people to participate as couriers in a type of crowdsourced service economy. Here, essentially any person with a mobile device is able to immediately become a courier, or cease to be a courier, in a courier network that provides services as described herein. In at least one example, the couriers can be unmanned aerial vehicles (e.g., drones), autonomous vehicles, or any other type of vehicle capable of receiving instructions for traveling between locations. In some examples, the service provider 812 can receive requests for courier services, automatically assign the requests to active couriers, and communicate dispatch instructions to couriers via user interface (e.g., application, web browser, or other access point) presented via respective devices 806.

In some examples, the service provider 812 can provide omni-channel fulfillment services. For instance, if a customer places an order with a merchant and the merchant cannot fulfill the order because one or more items are out of stock or otherwise unavailable, the service provider 812 can leverage other merchants and/or sales channels that are part of the platform of the service provider 812 to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the service provider 812 can enable conversational commerce via conversational commerce services, which can use one or more machine learning mechanisms to analyze messages exchanged between two or more users 814, voice inputs into a virtual assistant or the like, to determine intents of user(s) 814. In some examples, the service provider 812 can utilize determined intents to automate customer service, offer promotions, provide recommendations, or otherwise interact with customers in real-time. In at least one example, the service provider 812 can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, the service provider 812 can provide a peer-to-peer payment service that enables peer-to-peer payments between two or more users 814. In at least one example, the service provider 812 can communicate with instances of a payment application (or other access point) installed on user devices 806 configured for operation by users 814. In an example, an instance of the payment application executing on a first device operated by a payor can send a request to the service provider 812 to transfer an amount of funds (e.g., fiat currency or non-fiat currency such as cryptocurrency, securities, and related assets) from an account of the payor to an account of a payee (e.g., a peer-to-peer payment). The service provider 812 can facilitate the transfer and can send a notification to an instance of the payment application executing on a second mobile device operated by the payee that the transfer is in process (or has been completed). In some examples, the service provider 812 can send additional or alternative information to the instances of the payment application (e.g., low balance to the payor, current balance to the payor or the payee, etc.). In some implementations, the payor and/or payee can be identified automatically, e.g., based on context, proximity, prior transaction history, and so on. In other examples, the payee can send a request for funds to the payor prior to the payor initiating the transfer of funds. The funds transferred can be associated with any digital currency type, including, but not limited to, cash, cryptocurrency, etc. In some embodiments, the service provider 812 funds the request to payee on behalf of the payor, to speed up the transfer process and compensate for any lags that may be attributed to payor's financial network.

In some implementations, the service provider 812 can trigger the peer-to-peer payment process through identification of a “payment proxy” having a particular syntax. For example, the syntax includes a monetary currency indicator prefixing one or more alphanumeric characters (e.g., $Cash). The currency indicator operates as the tagging mechanism that indicates to a computer system to treat the inputs as a request from the sender to transfer cash, where detection of the syntax (which includes one or more alphanumeric characters tagged by a monetary currency indicator) triggers a transfer of cash. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol could equally be used. The peer-to-peer process can be initiated through a particular application executing on the user devices 806.

In some embodiments, the peer-to-peer process can be implemented within a forum context. The term “forum,” as used here, refers to a content provider's media channel (e.g., a social networking platform, a microblog, a blog, video sharing platform, a music sharing platform, etc.) that enables user interaction and engagement through comments, posts, messages on electronic bulletin boards, messages on a social networking platform, and/or any other types of messages. The forum can be employed by a content provider to enable users of the forum to interact with one another, (e.g., through creating messages, posting comments, etc.). In some embodiments, “forum” may also refer to an application or webpage of an e-commerce or retail organization that offers products and/or services. Such websites can provide an online “form” to complete before or after the products or services are added to a virtual cart. The online form may include one or more fields to receive user interaction and engagement. Examples include name and other identification of the user, shipping address of the user, etc. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application context, such as a messaging application context. The term “messaging application,” as used here, refers to any messaging application that enables communication between users (e.g., sender and recipient of a message) over a wired or wireless communications network, through use of a communication message. The messaging application can be employed by the service provider 812. For instance, the service provider 812 can offer messaging services that provides a communication service to users via a messaging application (e.g., chat or messaging capability). The messaging application can include, for example, a text messaging application for communication between phones (e.g., conventional mobile telephones or smartphones), or a cross-platform instant messaging application for smartphones and phones that use the Internet for communication. The messaging application can be executed on a user device 806 (e.g., mobile device or conventional personal computer (PC)) based on instructions transmitted to and from the server computing device(s) 802 (which, in such an example can be called a “messaging server”). In some instances, the messaging application can include a payment application with messaging capability that enables users of the payment application to communicate with one another. In such instances, the payment application can be executed on the a user device 806 based on instructions transmitted to and from the server computing device(s) 802 (e.g., the payment service discussed in this description or another payment service that supports payment transactions).

In at least some embodiments, the peer-to-peer process can be implemented within a landing page context. The term “landing page,” as used here, refers to a virtual location identified by a personalized location address that is dedicated to collect payments on behalf of a recipient associated with the personalized location address. The personalized location address that identifies the landing page can include a payment proxy discussed above. The service provider 812 can generate the landing page to enable the recipient to conveniently receive one or more payments from one or more senders. In some embodiments, the personalized location address identifying the landing page is a uniform resource locator (URL) that incorporates the payment proxy. In such embodiments, the landing page is a web page, e.g., www.cash.me/$Cash.

In at least one example, a user 814 may be new to the service provider 812 such that the user 814 that has not registered (e.g., subscribed to receive access to one or more services offered by the service provider) with the service provider 812. The service provider 812 can offer onboarding services for registering a potential user 814 with the service provider 812. In some examples, onboarding can involve presenting various questions, prompts, and the like to a potential user 814 to obtain information that can be used to generate a profile for the potential user 814. In at least one example, the service provider 812 can provide limited or short-term access to its services prior to, or during, onboarding (e.g., a user of a peer-to-peer payment service can transfer and/or receive funds prior to being fully onboarded, a merchant can process payments prior to being fully onboarded, etc.). In at least one example, responsive to the potential user 814 providing all necessary information, the potential user 814 can be onboarded to the service provider 812. In such an example, any limited or short-term access to services of the service provider 812 can be transitioned to more permissive (e.g., less limited) or longer-term access to such services.

The service provider 812 can be associated with IDV services, which can be used by the service provider 812 for compliance purposes and/or can be offered as a service, for instance to third-party service providers (e.g., associated with the server computing device(s) 810). That is, the service provider 812 can offer IDV services to verify the identity of users 814 seeking to use or using their services. Identity verification requires a customer (or potential customer) to provide information that is used by compliance departments to prove that the information is associated with an identity of a real person or entity. In at least one example, the service provider 812 can perform services for determining whether identifying information provided by a user 814 accurately identifies the customer (or potential customer) (i.e., Is the customer who they say they are?).

The service provider 812 is capable of providing additional or alternative services and the services described above are offered as a sampling of services. In at least one example, the service provider 812 can exchange data with the server computing device(s) 810 associated with third-party service providers. Such third-party service providers can provide information that enables the service provider 812 to provide services, such as those described above. In additional or alternative examples, such third-party service providers can access services of the service provider 812. That is, in some examples, the third-party service providers can be subscribers, or otherwise access, services of the service provider 812.

Techniques described herein can be configured to operate in both real-time/online and offline modes. “Online” modes refer to modes when devices are capable of communicating with the service provider 812 (e.g., the server computing device(s) 802) and/or the server computing device(s) 810 via the network(s) 804. In some examples, the merchant device(s) 808 are not capable of connecting with the service provider 812 (e.g., the server computing device(s) 802) and/or the server computing device(s) 810, due to a network connectivity issue, for example. In additional or alternative examples, the server computing device(s) 802 are not capable of communicating with the server computing device(s) 810 due to network connectivity issue, for example. In such examples, devices may operate in “offline” mode where at least some payment data is stored (e.g., on the merchant device(s) 808) and/or the server computing device(s) 802 until connectivity is restored and the payment data can be transmitted to the server computing device(s) 802 and/or the server computing device(s) 810 for processing.

In at least one example, the service provider 812 can be associated with a hub, such as an order hub, an inventory hub, a fulfillment hub and so on, which can enable integration with one or more additional service providers (e.g., associated with the additional server computing device(s) 810). In some examples, such additional service providers can offer additional or alternative services and the service provider 812 can provide an interface or other computer-readable instructions to integrate functionality of the service provider 812 into the one or more additional service providers.

Techniques described herein are directed to services provided via a distributed system of user devices 806 that are in communication with one or more server computing devices 802 of the service provider 812. That is, techniques described herein are directed to a specific implementation—or, a practical application—of utilizing a distributed system of user devices 806 that are in communication with one or more server computing devices 802 of the service provider 812 to perform a variety of services, as described above. The unconventional configuration of the distributed system described herein enables the server computing device(s) 802 that are remotely-located from end-users (e.g., users 814) to intelligently offer services based on aggregated data associated with the end-users, such as the users 814 (e.g., data associated with multiple, different merchants and/or multiple, different buyers), in some examples, in near-real time. Accordingly, techniques described herein are directed to a particular arrangement of elements that offer technical improvements over conventional techniques for performing payment processing services and the like. For small business owners in particular, the business environment is typically fragmented and relies on unrelated tools and programs, making it difficult for an owner to manually consolidate and view such data. The techniques described herein constantly or periodically monitor disparate and distinct merchant accounts, e.g., accounts within the control of the service provider 812, and those outside of the control of the service provider 812, to track the business standing (payables, receivables, payroll, invoices, appointments, capital, etc.) of the merchants. The techniques herein provide a consolidated view of a merchant's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services and/or additional or alternative services described herein. In some implementations, the distributed system is capable of applying the intelligence derived from an existing user base to a new user, thereby making the onboarding experience for the new user personalized and frictionless when compared to traditional onboarding methods. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 814 and user devices 806. Furthermore, such features are changed dynamically based on the profiles of the users involved interacting with the GUIs. As such, techniques described herein are directed to improvements to computing systems.

FIG. 9 depicts an illustrative block diagram illustrating a system 900 for performing techniques described herein. The system 900 includes a user device 902, that communicates with server computing device(s) (e.g., server(s) 904) via network(s) 906 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 902 is illustrated, in additional or alternate examples, the system 900 can have multiple user devices, as described above with reference to FIG. 8.

In at least one example, the server(s) 102 of FIG. 1 can correspond to the server(s) 904, the payor computing device 132 and/or the payee computing device 146 of FIG. 1 can correspond to the user device 902, and the network(s) 136 of FIG. 1 can correspond to the network(s) 906.

In at least one example, the user device 902 can be any suitable type of computing device, e.g., portable, semi-portable, semi-stationary, or stationary. Some examples of the user device 902 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. That is, the user device 902 can be any computing device capable of sending communications and performing the functions according to the techniques described herein. The user device 902 can include devices, e.g., payment card readers, or components capable of accepting payments, as described below.

In the illustrated example, the user device 902 includes one or more processors 908, one or more computer-readable media 910, one or more communication interface(s) 912, one or more input/output (I/O) devices 914, a display 916, and sensor(s) 918.

In at least one example, each processor 908 can itself comprise one or more processors or processing cores. For example, the processor(s) 908 can be implemented as one or more microprocessors, microcomputers, microcontrollers, digital signal processors, central processing units, state machines, logic circuitries, and/or any devices that manipulate signals based on operational instructions. In some examples, the processor(s) 908 can be one or more hardware processors and/or logic circuits of any suitable type specifically programmed or configured to execute the algorithms and processes described herein. The processor(s) 908 can be configured to fetch and execute computer-readable processor-executable instructions stored in the computer-readable media 910.

Depending on the configuration of the user device 902, the computer-readable media 910 can be an example of tangible non-transitory computer storage media and can include volatile and nonvolatile memory and/or removable and non-removable media implemented in any type of technology for storage of information such as computer-readable processor-executable instructions, data structures, program modules or other data. The computer-readable media 910 can include, but is not limited to, RAM, ROM, EEPROM, flash memory, solid-state storage, magnetic disk storage, optical storage, and/or other computer-readable media technology. Further, in some examples, the user device 902 can access external storage, such as RAID storage systems, storage arrays, network attached storage, storage area networks, cloud storage, or any other medium that can be used to store information and that can be accessed by the processor(s) 908 directly or through another computing device or network. Accordingly, the computer-readable media 910 can be computer storage media able to store instructions, modules or components that can be executed by the processor(s) 908. Further, when mentioned, non-transitory computer-readable media exclude media such as energy, carrier signals, electromagnetic waves, and signals per se.

The computer-readable media 910 can be used to store and maintain any number of functional components that are executable by the processor(s) 908. In some implementations, these functional components comprise instructions or programs that are executable by the processor(s) 908 and that, when executed, implement operational logic for performing the actions and services attributed above to the user device 902. Functional components stored in the computer-readable media 910 can include a user interface 920 to enable users to interact with the user device 902, and thus the server(s) 904 and/or other networked devices. In at least one example, the user interface 920 can be presented via a web browser, or the like. In other examples, the user interface 920 can be presented via an application, such as a mobile application or desktop application, which can be provided by a service provider 812 associated with the server(s) 904, or which can be an otherwise dedicated application. In some examples, the user interface 920 can be the payor user interface 134, of FIG. 1, or the payee user interface 148, of FIG. 1. In at least one example, a user can interact with the user interface via touch input, spoken input, gesture, or any other type of input. The word “input” is also used to describe “contextual” input that may not be directly provided by the user via the user interface 920. For example, user's interactions with the user interface 920 are analyzed using, e.g., natural language processing techniques, to determine context or intent of the user, which may be treated in a manner similar to “direct” user input.

Depending on the type of the user device 902, the computer-readable media 910 can also optionally include other functional components and data 922, which can include programs, drivers, etc., and the data used or generated by the functional components. In addition, the computer-readable media 910 can also store data, data structures and the like, that are used by the functional components. Further, the user device 902 can include many other logical, programmatic and physical components, of which those described are merely examples that are related to the discussion herein.

In at least one example, the computer-readable media 910 can include additional functional components, such as an operating system 924 for controlling and managing various functions of the user device 902 and for enabling basic user interactions.

The communication interface(s) 912 can include one or more interfaces and hardware components for enabling communication with various other devices, such as over the network(s) 906 or directly. For example, communication interface(s) 912 can enable communication through one or more network(s) 906, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 906 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 902 can further include one or more input/output (I/O) devices 914. The I/O devices 914 can include speakers, a microphone, a camera, and various user controls (e.g., buttons, a joystick, a keyboard, a keypad, etc.), a haptic output device, and so forth. The I/O devices 914 can also include attachments that leverage the accessories (audio-jack, USB-C, Bluetooth, etc.) to connect with the user device 902.

In at least one example, user device 902 can include a display 916. Depending on the type of computing device(s) used as the user device 902, the display 916 can employ any suitable display technology. For example, the display 916 can be a liquid crystal display, a plasma display, a light emitting diode display, an OLED (organic light-emitting diode) display, an electronic paper display, or any other suitable type of display able to present digital content thereon. In at least one example, the display 916 can be an augmented reality display, a virtually reality display, or any other display able to present and/or project digital content. In some examples, the display 916 can have a touch sensor associated with the display 916 to provide a touchscreen display configured to receive touch inputs for enabling interaction with a graphic interface presented on the display 916. Accordingly, implementations herein are not limited to any particular display technology. Alternatively, in some examples, the user device 902 may not include the display 916, and information can be presented by other means, such as aurally, hapticly, etc.

In addition, the user device 902 can include sensor(s) 918. The sensor(s) 918 can include a GPS device able to indicate location information. Further, the sensor(s) 918 can include, but are not limited to, an accelerometer, gyroscope, compass, proximity sensor, camera, microphone, and/or a switch.

In some example, the GPS device can be used to identify a location of a user. In at least one example, the location of the user can be used by the service provider 812, described above, to provide one or more services. That is, in some examples, the service provider 812 can implement geofencing to provide particular services to users. As an example, with a lending service, location can be used to confirm that a stated purpose of a loan corresponds to evidence of use (e.g., Is the user using the loan consistent with what he or she said he or she was going to use it for?). Furthermore, in some examples, location can be used for payroll purposes. As an example, if a contractor completes a project, the contractor can provide a geo-tagged image (e.g., tagged based on location information availed by the GPS device). In some examples, location can be used for facilitating peer-to-peer payments between nearby users 814 and/or for sending users 814 notifications regarding available appointments with merchant(s) located proximate to the users 814. In at least one example, location can be used for taking payments from nearby customers when they leave a geofence, or location can be used to initiate an action responsive to users 814 enter a brick-and-mortar store of a merchant. Location can be used in additional or alternative ways as well.

Additionally, the user device 902 can include various other components that are not shown, examples of which include removable storage, a power source, such as a battery and power control unit, a barcode scanner, a printer, a cash drawer, and so forth.

In addition, in some examples, the user device 902 can include, be connectable to, or otherwise be coupled to a reader device 926, for reading payment instruments and/or identifiers associated with payment objects. In some examples, as described above, the reader device 926 can plug in to a port in the user device 902, such as a microphone port, a headphone port, an audio-jack, a data port, or other suitable port. In additional or alternative examples, the reader device 926 can be coupled to the user device 902 via another wired or wireless connection, such as via a Bluetooth®, BLE, and so on. The reader device 926 can include a read head for reading a magnetic strip of a payment card, and further can include encryption technology for encrypting the information read from the magnetic strip. Additionally or alternatively, the reader device 926 can be an EMV payment reader, which in some examples, can be embedded in the user device 902. Moreover, numerous other types of readers can be employed with the user device 902 herein, depending on the type and configuration of the user device 902.

The reader device 926 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data off any payment instrument. Accordingly, the reader device 926 may include hardware implementation, such as slots, magnetic tracks, and rails with one or more sensors or electrical contacts to facilitate detection and acceptance of a payment instrument. That is, the reader device 926 may include hardware implementations to enable the reader device 926 to interact with a payment instrument via a swipe (i.e., a card-present transaction where a customer slides a card having a magnetic strip through a payment reader that captures payment data contained in the magnetic strip), a dip (i.e., a card-present transaction where a customer inserts a card having an embedded microchip (i.e., chip) into a payment reader first until the payment reader prompts the customer to remove the card), or a tap (i.e., a card-present transaction where a customer may tap or hover his or her electronic device such as a smart phone running a payment application over a payment reader to complete a transaction via short-range communication) to obtain payment data associated with a customer. Additionally or optionally, the reader device 926 may also include a biometric sensor to receive and process biometric characteristics and process them as payment instruments, given that such biometric characteristics are registered with the service provider and connected to a financial account with a bank server.

The reader device 926 may include processing unit(s), computer-readable media, a reader chip, a transaction chip, a timer, a clock, a network interface, a power supply, and so on. The processing unit(s) of the reader device 926 may execute one or more modules and/or processes to cause the reader device 926 to perform a variety of functions, as set forth above and explained in further detail in the following disclosure. In some examples, the processing unit(s) may include a central processing unit (CPU), a graphics processing unit (GPU), a CPU and a GPU, or processing units or components known in the art. Additionally, each of the processing unit(s) may possess its own local memory, which also may store program modules, program data, and/or one or more operating systems. Depending on the exact configuration and type of the reader device 926, the computer-readable media may include volatile memory (such as RAM), non-volatile memory (such as ROM, flash memory, miniature hard drive, memory card, or the like), or some combination thereof. In at least one example, the computer-readable media of the reader device 926 may include at least one module for performing various functions as described herein.

The reader chip may perform functionalities to control the operations and processing of the reader device 926. That is, the reader chip may perform functionalities to control payment interfaces (e.g., a contactless interface, a contact interface, etc.), a wireless communication interface, a wired interface, a user interface (e.g., a signal condition device (FPGA)), etc. Additionally, the reader chip may perform functionality to control the timer, which may provide a timer signal indicating an amount of time that has lapsed following a particular event (e.g., an interaction, a power-down event, etc.). Moreover, the reader chip may perform functionality to control the clock, which may provide a clock signal indicating a time. Furthermore, the reader chip may perform functionality to control the network interface, which may interface with the network(s) 906, as described below.

Additionally, the reader chip may perform functionality to control the power supply. The power supply may include one or more power supplies such as a physical connection to AC power or a battery. Power supply may include power conversion circuitry for converting AC power and generating a plurality of DC voltages for use by components of reader device 926. When power supply includes a battery, the battery may be charged via a physical power connection, via inductive charging, or via any other suitable method.

The transaction chip may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. Additionally, the transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While, the user device 902, which can be a POS terminal, and the reader device 926 are shown as separate devices, in additional or alternative examples, the user device 902 and the reader device 926 can be part of a single device, which may be a battery-operated device. In such an example, components of both the user device 902 and the reader device 926 may be associated with the single device. In some examples, the reader device 926 can have a display integrated therewith, which can be in addition to (or as an alternative of) the display 916 associated with the user device 902.

The server(s) 904 can include one or more servers or other types of computing devices that can be embodied in any number of ways. For example, in the example of a server, the modules, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 904 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 904 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 904 can include one or more processors 928, one or more computer-readable media 930, one or more I/O devices 932, and one or more communication interfaces 934. Each processor 928 can be a single processing unit or a number of processing units, and can include single or multiple computing units or multiple processing cores. The processor(s) 928 can be implemented as one or more microprocessors, microcomputers, microcontrollers, digital signal processors, central processing units, state machines, logic circuitries, and/or any devices that manipulate signals based on operational instructions. For example, the processor(s) 928 can be one or more hardware processors and/or logic circuits of any suitable type specifically programmed or configured to execute the algorithms and processes described herein. The processor(s) 928 can be configured to fetch and execute computer-readable instructions stored in the computer-readable media 930, which can program the processor(s) 928 to perform the functions described herein.

The computer-readable media 930 can include volatile and nonvolatile memory and/or removable and non-removable media implemented in any type of technology for storage of information, such as computer-readable instructions, data structures, program modules, or other data. Such computer-readable media 930 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 904, the computer-readable media 930 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 930 can be used to store any number of functional components that are executable by the processor(s) 928. In many implementations, these functional components comprise instructions or programs that are executable by the processors 928 and that, when executed, specifically configure the one or more processors 928 to perform the actions attributed above to the service provider 812 and/or payment processing service. Functional components stored in the computer-readable media 930 can include components and data 936, which are described above with reference to FIG. 1. Further, the server(s) 904 can include many other logical, programmatic and physical components, of which those described above are merely examples that are related to the discussion herein.

The one or more “functional components” or “components” referenced herein may be implemented as more modules or as fewer modules, and functions described for the modules may be redistributed depending on the details of the implementation. The term “module,” as used herein, refers broadly to software stored on non-transitory storage medium (e.g., volatile or non-volatile memory for a computing device), hardware, or firmware (or any combination thereof) modules. Modules are typically functional such that they that may generate useful data or other output using specified input(s). A module may or may not be self-contained. An application program (also called an “application”) may include one or more modules, or a module may include one or more application programs that can be accessed over a network or downloaded as software onto a device (e.g., executable code causing the device to perform an action). An application program (also called an “application”) may include one or more modules, or a module may include one or more application programs. In additional and/or alternative examples, the module(s) may be implemented as computer-readable instructions, various data structures, and so forth via at least one processing unit to configure the computing device(s) described herein to execute instructions and to perform operations as described herein.

In some examples, a module may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) exposed to the third-party systems can enable third-party developers to customize how their respective third-party applications interact with the service provider or vice versa.

The computer-readable media 930 can additionally include an operating system 938 for controlling and managing various functions of the server(s) 904.

The communication interface(s) 934 can include one or more interfaces and hardware components for enabling communication with various other devices, such as over the network(s) 906 or directly. For example, communication interface(s) 934 can enable communication through one or more network(s) 906, which can include, but are not limited any type of network known in the art, such as a local area network or a wide area network, such as the Internet, and can include a wireless network, such as a cellular network, a local wireless network, such as Wi-Fi and/or close-range wireless communications, such as Bluetooth®, BLE, NFC, RFID, a wired network, or any other such network, or any combination thereof. Accordingly, network(s) 906 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

The server(s) 904 can further be equipped with various I/O devices 932. Such I/O devices 932 can include a display, various user interface controls (e.g., buttons, joystick, keyboard, mouse, touch screen, biometric or sensory input devices, etc.), audio speakers, connection ports and so forth.

In at least one example, the system 900 can include one or more data stores 940 that can be configured to store data that is accessible, manageable, and updatable. In some examples, the data store(s) 940 can be integrated with the user device 902 and/or the server(s) 904. In other examples, as shown in FIG. 9, the data store(s) 940 can be located remotely from the server(s) 904 and can be accessible to the server(s) 904. The data store(s) 940 can comprise multiple databases and/or servers connected locally and/or remotely via the network(s) 906.

In at least one example, the data store(s) 940 can store user profiles, which can include merchant profiles, customer profiles, and so on. Additionally or alternatively, the data store(s) 940 can store data as described above with reference to FIG. 1.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider 812.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, etc.

Furthermore, in at least one example, the data store(s) 940 can store inventory database(s) and/or catalog database(s). As described above, an inventory can store data associated with a quantity of each item that a merchant has available to the merchant. Furthermore, a catalog can store data associated with items that a merchant has available for acquisition. The data store(s) 940 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to FIGS. 1, 8, and 9 for convenience and ease of understanding. However, the methods illustrated are not limited to being performed using components described in FIGS. 1, 8, and 9, and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

### EXAMPLE CLAUSES

A. A method, implemented at least in part by a computing device of a service provider, comprising: receiving, by the computing device and via a payor user interface provided by the service provider, electronic records associated with a payor; accessing, by the computing device and from payor data stored by the service provider, a stored balance of the payor managed by the service provider; recommending, by the computing device and using a machine-trained model, that a payment associated with a first electronic record of the electronic records be paid using a portion of the stored balance; settling, by the computing device, the payment associated with a first electronic record using the portion of the stored balance in response to the recommendation; generating, by the computing device and based at least in part on the payor data, a credit offer for the payor to settle a payment associated with a second electronic record of the electronic records; and based at least in part on a determination that the payor accepts the credit offer, settling, by the computing device, the payment associated with the second electronic record using a preferred form of payment for the payee.

B. The method as clause A recites, wherein each electronic record indicates at least one of (i) an amount to be paid by the payor to a respective payee, (ii) a due date, or (iii) acceptable forms of payment.

C. The method as clause A or B recites, wherein the preferred form of payment comprises a check, an electronic funds transfer, cryptocurrency, a peer-to-peer payment, a real-time payment, a debit card, or a credit card.

D. The method as any of clauses A-C recites, further comprising: based at least in part on settling the payment associated with the first electronic record using the portion of the stored balance, reducing the stored balance by the portion of the stored balance; and determining that (i) a remaining portion of the stored balance is insufficient to satisfy an amount to be paid in association with the second electronic record or (ii) an optimal payment mechanism, for the payor, associated with the second electronic record comprises credit, wherein the credit offer is generated based at least in part on (i) a determination that the remaining portion of the stored balance is insufficient to satisfy the amount to be paid in association with the second electronic record or (ii) a determination that the optimal payment mechanism, for the payor, associated with the second electronic record comprises credit.

E. The method as any of clauses A-D recites, wherein the machine-trained model is trained to output at least one of an optimal form of payment or an optimal date for submitting a payment associated with a particular electronic record of the electronic records.

F. The method as any of clauses A-E recites, further comprising: receiving a request to retrieve one or more electronic records associated with the payor; and extracting, in response to receiving the request, relevant electronic records based on priority associated with individual of the electronic records, wherein the first electronic record and the second electronic record are two of the relevant electronic records.

G. A system comprising: one or more processors; and one or more non-transitory computer-readable media storing instructions, that when executed by the one or more processors, cause the system to perform operations comprising: receiving, via a payor user interface provided by a service provider, one or more electronic records associated with a payor; extracting relevant electronic records based on priority; recommending, using a machine-trained model and based on characteristics of a first electronic record of the relevant electronic records and a second electronic record of the relevant electronic records, that a payment associated with the first electronic record be paid using a first form of payment, and another payment associated with the second electronic record be paid using a second form of payment; settling, based at least in part on the recommendation, the payment associated with the first electronic record using the first form of payment; and independently settling the other payment associated with the second electronic record using a second form of payment.

H. The system as clause G recites, wherein the second form of payment comprises credit, the operations further comprising generating a credit offer for the payor based at least in part on payor data associated with the payor, and wherein settling the payment associated with the second electronic record is based at least in part on a determination that the payor accepts the credit offer.

I. The system as clause H recites, wherein the first form of payment comprises a stored balance of the payor, the operations further comprising: using a portion of the stored balance to settle the payment associated with the first electronic record; based at least in part on settling the payment associated with the first electronic record using the portion of the stored balance, reducing the stored balance by the portion of the stored balance; and determining that a remaining portion of the stored balance is insufficient to satisfy an amount to be paid in association with the second electronic record, wherein the credit offer is generated based at least in part on a determination that the remaining portion of the stored balance is insufficient to satisfy the amount to be paid in association with the second electronic record.

J. The system as clause I recites, further comprising recommending, using the machine-trained model, that the payment associated with the second electronic record be paid via a preferred form of payment of the payee, wherein the credit offer is generated further based at least in part on a recommendation that the payment associated with the second electronic record be paid via the preferred form of payment for the payee.

K. The system as any of clauses H-J recites, the operations further comprising increasing a credit balance associated with the payor based at least in part on the determination that the payor accepts the credit offer, wherein the credit balance is managed by the service provider and is associated with a repayment period that extends beyond a due date for payment of the second electronic record.

L. The system as any of clauses G-K recites, wherein each electronic record is associated with record data indicating at least one of (i) an amount to be paid by the payor to a respective payee, (ii) a due date, or (iii) acceptable forms of payment.

M. The system as any of clauses G-L recites, wherein a recommendation that the payment associated with the first electronic record should be paid using a first form of payment is based at least in part on one or more of (i) payor data associated with the payor, (ii) first record data associated with the first electronic record, or (iii) second record data associated with the electronic records.

N. The system as any of clauses G-M recites, wherein the first form of payment comprises a combination of two different forms of payment.

O. The system as any of clauses G-N recites, wherein the first form of payment comprises a stored balance associated with a payment instrument, wherein settling the payment associated with the second electronic record comprises providing payment data associated with the payment instrument to the payee for using another portion of the stored balance, and wherein a transaction history associated with the stored balance indicates one or more previous transactions in which the stored balance was used for payment, the operations further comprising: based at least in part on settling the payment associated with the first electronic record using the portion of the stored balance, adding a first new transaction to the transaction history associated with the stored balance; and based at least in part on settling the payment associated with the second electronic record using the other portion of the stored balance, adding a second new transaction to the transaction history associated with the stored balance.

P. One or more non-transitory computer-readable media storing instructions, that when executed by one or more processors, cause the one or more processors to perform operations comprising: receiving, via a payor user interface provided by a service provider, electronic records associated with a payor; recommending, using a machine-trained model and based at least in part on one or more of the electronic records, a first optimal payment mechanism for a payment associated with a first electronic record of the electronic records, wherein the first optimal payment mechanism indicates that the first electronic record be paid using a first form of payment on a first date; settling, on the first date, the payment for the first electronic record using the first form of payment; recommending, using the machine-trained model and based at least in part on the one or more of the electronic records, a second optimal payment mechanism for a payment associated with a second electronic record of the electronic records, wherein the second optimal payment mechanism indicates that the second electronic record be paid using a second form of payment on a second date; and settling, on the second date, the payment associated with the second electronic record using the second form of payment.

Q. The one or more non-transitory computer-readable media as clause P recites, further comprising: accessing aggregated payor data of payors associated with the service provider; accessing record data associated with aggregated electronic records received via the payor user interface; and training, using a machine learning mechanism, the machine-trained model based at least in part on the aggregated payor data and the record data.

R. The one or more non-transitory computer-readable media as clause P or Q recites, further comprising determining at least one of the first optimal payment mechanism or the second optimal payment mechanism, using the machine-trained model, based at least in part on one or more of: due dates associated with payment of the electronic records; payment terms associated with payment of the electronic records; preferred forms of payment for payment of the electronic records; fees associated with payment of the electronic records; incentives associated with payment of the electronic records; payor data associated with the payor; or a credit signal associated with the payor.

S. The one or more non-transitory computer-readable media as any of clauses P-R recites, the operations further comprising: generating a credit offer for the payor to settle the payment associated with the second electronic record; and sending the credit offer to a computing device of the payor, wherein the credit offer is associated with an incentive for the payor, wherein settling the payment associated with the second electronic record is based at least in part on a determination that the payor accepted the credit offer.

T. The one or more non-transitory computer-readable media as any of clauses P-S recites, wherein the first form of payment is associated with a stored balance that is generated based at least in part on one or more of: proceeds of one or more payments processed by the service provider on behalf of the payor; one or more peer-to-peer payments received by service provider on behalf of the payor; or receivables of one or more invoices invoiced by the service provider on behalf of the payor, and wherein the stored balance is reduced by settlement of one or more of the electronic records using at least one of portion of the stored balance or a payment instrument associated therewith.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

1. A method comprising:
receiving, by a computing device of a service provider and via a payor user interface provided by the service provider, a plurality of payor electronic records associated with a payor;
determining, by the computing device, that the plurality of payor electronic records includes at least one non-standardized payor electronic record that is in a format other than a standardized format, wherein the standardized format comprises a data format storable in a database associated with the service provider;
converting, by the computing device, the at least one non-standardized payor electronic record to the standardized format;
accessing, by the computing device and from payor data stored by the service provider, a stored balance of the payor, wherein the stored balance is managed by the service provider;
recommending, by the computing device and based at least in part on applying a machine-trained model and using as input record data associated with a first payor electronic record of the plurality of payor electronic records, that a payment associated with the first payor electronic record be paid using funds from the stored balance, wherein training data for the machine-trained model includes a plurality of other electronic records associated with other payors and received via other payor user interfaces associated with the other payors;
settling, by the computing device, the payment associated with the first payor electronic record using the funds from the stored balance;
generating, by the computing device and based at least in part on the payor data, a credit offer for the payor to settle a payment associated with a second payor electronic record of the plurality of payor electronic records; and
based at least in part on a determination that the payor accepts the credit offer, settling, by the computing device, the payment associated with the second payor electronic record using a preferred form of payment for the payee.

2. The method as claim 1 recites, wherein each payor electronic record of the plurality of payor electronic records and the plurality of other electronic records indicates at least one of (i) a payment amount associated with the payor electronic record, (ii) a due date, or (iii) acceptable forms of payment.

3. The method as claim 1 recites, wherein the preferred form of payment comprises a check, an electronic funds transfer, cryptocurrency, a peer-to-peer payment, a real-time payment, a debit card, or a credit card.

4. The method as claim 1 recites, wherein the machine-trained model comprises a first machine-trained model, and the method further comprising:
based at least in part on settling the payment associated with the first payor electronic record using the funds from the stored balance, reducing, by the computing device, the stored balance to an updated stored balance by deducting an amount corresponding to the funds; and
determining, by the computing device, that (i) the updated stored balance is insufficient to satisfy an amount to be paid in association with the second payor electronic record or (ii) based at least in part on the machine-trained model or a second machine-trained model, that an optimal payment mechanism, for the payor, associated with the second payor electronic record comprises credit,
wherein the credit offer is generated based at least in part on (i) a determination that the updated stored balance is insufficient to satisfy the amount to be paid in association with the second payor electronic record or (ii) a determination that the optimal payment mechanism, for the payor, associated with the second payor electronic record comprises credit.

5. The method as claim 1 recites, wherein the machine-trained model is trained to output at least one of an optimal form of payment or an optimal date of a payment associated with a particular payor electronic record of the plurality of payor electronic records.

6. The method as claim 1 recites, further comprising:
processing, by the computing device, the plurality of payor electronic records to determine one or more contexts of individual payor electronic records of the plurality of payor electronic records, wherein context comprises at least one of a payor, a payee, an urgency, or a payor preference associated with an individual payor electronic record;
receiving, by the computing device, a request to retrieve one or more payor electronic records, of the plurality of payor electronic records, associated with the payor and a context of the one or more contexts; and
extracting, by the computing device and in response to receiving the request, a subset of payor electronic records of the plurality of payor electronic records based at least in part on the context of the plurality of payor electronic records, wherein the first payor electronic record and the second payor electronic record are two of the subset.

7. One or more computing devices comprising:
one or more processors; and
one or more non-transitory computer-readable media storing instructions, that when executed by the one or more processors, cause the one or more processors to perform operations comprising:
receiving, via a payor user interface provided by a service provider, one or more payor electronic records associated with a payor;
determining that the one or more payor electronic records includes at least one non-standardized payor electronic record that is in a format other than a standardized format, wherein the standardized format comprises a data format storable in a database associated with the service provider;
converting the at least one non-standardized payor electronic record to the standardized format
recommending, based at least in part on applying a machine-trained model and using as input characteristics of a first payor electronic record of the one or more payor electronic records and a second payor electronic record of the one or more payor electronic records as input, that a payment associated with the first payor electronic record be paid using a first form of payment, and another payment associated with the second payor electronic record be paid using a second form of payment, wherein training data for the machine-trained model includes one or more other electronic records associated with one or more other payors and received via one or more payor user interfaces associated with the one or more other payors;
settling, based at least in part on the recommendation, the payment associated with the first payor electronic record using the first form of payment; and
independently settling the another payment associated with the second payor electronic record using the second form of payment.

8. The one or more computing devices as claim 7 recites, wherein the second form of payment comprises credit, the operations further comprising generating a credit offer for the payor based at least in part on payor data associated with the payor, and wherein settling the payment associated with the second payor electronic record is based at least in part on a determination that the payor accepts the credit offer.

9. (canceled)

10. The one or more computing devices as claim 9 recites, further comprising recommending, using the machine-trained model, that the payment associated with the second payor electronic record be paid via a preferred form of payment of the payee, wherein the credit offer is generated further based at least in part on a recommendation that the payment associated with the second payor electronic record be paid via the preferred form of payment for the payee.

11. The one or more computing devices as claim 8 recites, the operations further comprising increasing a credit balance associated with the payor based at least in part on the determination that the payor accepts the credit offer, wherein the credit balance is managed by the service provider and is associated with a repayment period that extends beyond a due date for payment of the second payor electronic record.

12. The one or more computing devices as claim 7 recites, wherein each payor electronic record of the one or more payor electronic records is associated with record data indicating at least one of (i) a payment amount associated with the payor electronic record, (ii) a due date, or (iii) acceptable forms of payment.

13. The one or more computing devices as claim 7 recites, wherein recommending that the payment associated with the first payor electronic record should be paid using the first form of payment is based at least in part on one or more of (i) payor data associated with the payor, (ii) first record data associated with the first payor electronic record, or (iii) second record data associated with the one or more payor electronic records.

14. The one or more computing devices as claim 7 recites, wherein the first form of payment comprises a combination of two different forms of payment.

15. The one or more computing devices as claim 7 recites, wherein the first form of payment comprises a stored balance associated with a payment instrument, wherein settling the payment associated with the second payor electronic record comprises providing payment data associated with the payment instrument to the payee for using funds from the stored balance, and wherein a transaction history associated with the stored balance indicates one or more previous transactions in which the stored balance was used for payment, the operations further comprising:
based at least in part on settling the payment associated with the first payor electronic record, adding a first new transaction to the transaction history associated with the stored balance; and
based at least in part on settling the payment associated with the second payor electronic record, adding a second new transaction to the transaction history associated with the stored balance.

16. One or more non-transitory computer-readable media storing instructions, that when executed by one or more processors, cause the one or more processors to perform operations comprising:
receiving, via a payor user interface provided by a service provider, a plurality of payor electronic records associated with a payor;
determining that the plurality of payor electronic records includes at least one non-standardized payor electronic record that is in a format other than a standardized format, wherein the standardized format comprises a data format storable in a database associated with the service provider;
converting the at least one non-standardized payor electronic record to the standardized format
recommending, based at least in part on applying a machine-trained model and using as input at least first record data associated with a first payor electronic record of the plurality of payor electronic records, a first optimal payment mechanism for a first payment associated with the first payor electronic record of the plurality of payor electronic records, wherein the first optimal payment mechanism indicates that the first payor electronic record be paid using a first form of payment on a first date;
settling, on the first date, the first payment associated with the first payor electronic record using the first form of payment;
recommending, based at least in part on applying the machine-trained model and using as input at least second record data associated with a second payor electronic record of the plurality of payor electronic records, a second optimal payment mechanism for a second payment associated with the second payor electronic record of the plurality of payor electronic records, wherein the second optimal payment mechanism indicates that the second payor electronic record be paid using a second form of payment on a second date; and
settling, on the second date, the second payment associated with the second payor electronic record using the second form of payment.

17. The one or more non-transitory computer-readable media as claim 16 recites, the operations further comprising:
accessing aggregated payor data of payors associated with the service provider;
accessing aggregated record data associated with aggregated electronic records received via the payor user interface; and
training, using a machine learning mechanism, the machine-trained model based at least in part on the aggregated payor data and the aggregated record data.

18. The one or more non-transitory computer-readable media as claim 16 recites, the operations further comprising determining at least one of the first optimal payment mechanism or the second optimal payment mechanism, using the machine-trained model, based at least in part on one or more of:
due dates associated with payment of the payor electronic records;
payment terms associated with the payment of the payor electronic records;
preferred forms of payment for the payment of the payor electronic records;
fees associated with the payment of the payor electronic records;
incentives associated with the payment of the payor electronic records;
payor data associated with the payor; or
a credit signal associated with the payor.

19. The one or more non-transitory computer-readable media as claim 16 recites, the operations further comprising:
generating a credit offer for the payor to settle the second payment associated with the second payor electronic record; and
sending the credit offer to a computing device of the payor, wherein the credit offer is associated with an incentive for the payor,
wherein settling the second payment associated with the second payor electronic record is based at least in part on a determination that the payor accepted the credit offer.

20. The one or more non-transitory computer-readable media as claim 16 recites, wherein the first form of payment is associated with a stored balance that is generated based at least in part on one or more of:
proceeds of one or more payments associated with the payor and processed by the service provider;
one or more peer-to-peer payments associated with the payor and received by the service provider;
receivables of one or more invoices associated with the payor and invoiced by the service provider, and
wherein the stored balance is reduced by settlement of one or more of the payor electronic records using at least one of funds from the stored balance or a payment instrument associated therewith.

21. The one or more non-transitory computer-readable media as claim 16 recites, wherein the machine-learned model requires that the first payor electronic record and the training data be in the standardized format.
